(19) United States
(12) Patent Application Publication
(10) Pub. No.: US 2015/0372911 A1
(43) Pub. Date: Dec. 24, 2015

(54) COMMUNICATION PATH MANAGEMENT METHOD

(71) Applicant: HITACHI, LTD., Tokyo (JP)

(72) Inventors: Hitoshi YABUSAKI, Tokyo (JP); Kunihiko TOUMURA, Tokyo (JP); Yoji OZAWA, Tokyo (JP); Takatoshi KATO, Tokyo (JP)

(21) Appl. No.: 14/765,097

(22) PCT Filed: Jan. 31, 2013
(86) PCT No.: PCT/JP2013/052202

§ 371 Date: Jul. 31, 2015

(51) Int. Cl. H04L 12/741; H04L 12/707

(52) U.S. Cl. CPC H04L 45/74; H04L 45/24

(57) ABSTRACT

A communication path management method has, servers that are coupled to communication devices and provide software, terminals that are coupled to the communication devices and use the software, and a network that couples the multiple communication devices, wherein the communication path management method establishes paths along which the terminals access the servers. The communication path management method comprises: a first step in which a management computer that is coupled to the network and that manages the communication devices and servers allocates, to each of a plurality of logical aggregate groups, a combination of terminals, to which the same server provides the software, and the software executed by the terminals; and a second step in which the management computer establishes communication paths of the communication devices for each of the aggregate groups.

### BACKGROUND

This invention relates to a network control apparatus configured to calculate a communication path and a destination to set the communication path and destination in a communication apparatus.

In recent years, there have been advancing cloud computing services, which run and manage a data center where pieces of data dispersed among separate bases are aggregated for the purpose of cutting IT cost. For cloud computing services, there has been developed a technology that allows a terminal intending to couple to software resources (virtual servers, application programs, and data) inside a remotely located data center to inquire an Internet Protocol (IP) address from a domain name server (DNS), and allows the DNS to send in response an IP address that is associated with a domain name received from the terminal. The technology of sending an IP address in response to a received domain name is referred to as name resolution in the following description. Name resolution enables a terminal to obtain the IP address of a server that provides a software resource, and to establish connection to a computer that provides the software resource by transmitting packets to the obtained IP address.

Name resolution has issues to be addressed in a situation where pieces of the same software are distributed among a plurality of data centers: balancing load and allowing a terminal to couple to its nearest data center. Load balancing is to distribute traffic among a plurality f servers in order to prevent a heavy concentration of traffic on some servers and the resultant strain on the servers' CPUs and memories and on communication lines along communication paths. A data center nearest to a terminal is a small-delay data center that is small in round trip time (RTT) in a round trip from the terminal. Name resolution does not allow a DNS to send in response to an inquiry made by a terminal the IP address of a server that is located in the terminal's nearest data center.

Meanwhile, software-defined networking (SDN) is being studied, which uses an external network control server to control transfer processing and the like of each communication apparatus in a centralized manner. For instance, OpenFlow is proposed on pages 6 to 21 of an online article titled “OpenFlow Switch Specification Version 1.3.0 (Wire Protocol 0x04)”, published on Jun. 25, 2012 by the Open Networking Foundation, and retrieved on Jul. 25, 2012. In OpenFlow, each communication apparatus keeps a flow table, which holds information such as an MAC address, an IP address, a protocol type, and a port number, and a traffic group prescribed by the flow table is defined as a flow. The network control server executes traffic processing (determining a transfer destination port, changing or discarding the destination IP address, a port number, and the transmission source IP address, and other types of processing) based on a rule (condition) that identifies a flow and on an action that lays down a processing method of the flow. Executing load balancing and failover with the use of this technology is being studied.

However, in load balancing and failover that use the OpenFlow technology, load balancing is accomplished by setting detailed flow entries, which is complicate processing that increases processing load on the network control server, and is expected to invite a delay in the processing of the network control server.

The related art that is concerned with the discussed problems is described below.

In order to solve the problem of name resolution, in U.S. Pat. No. 7,441,045 B2, an apparatus called an EDNS is used to vary the IP address that is sent in response to a received domain name from one local DNS (LDNS) to another. Each LDNS can thus send a different IP address in response to an IP address inquiry made by a terminal and, as a result, the load on CPUs and memories is balanced among a plurality of servers to which pieces of the same software are distributed. In addition, each LDNS can notify the IP address of a server that is geographically close to the LDNS to the terminal by obtaining the relationship between IP addresses and geographical sites. This enables the terminal to couple to a server the communication with which is small in delay.

In order to solve the problem of communication path control, in JP 2011-170718 A, a DNS round robin function is used to balance load in normal processing, while each of a plurality of service providing servers monitors its own load situation. When determining that the load on itself is equal to or more than a threshold, the service providing server issues a load balancing request to the network control server. In response to the load balancing request, the network control server changes flow entries set in communication apparatus (paragraphs 0013 to 0017). Load concentration that cannot be dealt with by load balancing that uses the round robin function is thus prevented, and processing load incurred on the network control server by processing of switching communication paths can be lightened as well.

In JP 2011-250033 A, there is an attempt to solve the problem of communication path control by building a redundancy configuration without providing an active server and a standby server for each communication network. To that end, when a monitoring server that monitors the communication situation under the Simple Network Management Protocol (SNMP) detects an anomaly, a standby server obtains the logical IP address of an active server where the failure has occurred and sets a relevant communication apparatus so that a switch to a communication path that leads to the standby server is made (paragraphs 0005 to 0007). A redundancy configuration can thus be formed without providing an active server and a standby server for each communication network.

### SUMMARY

Problems of the related art are described below.

Application programs for terminals are evolving to require communication that is small in delay and broad in bandwidth, while the total volume of a traffic flow in a wide area network is swelling. A future architecture is therefore expected to reduce the scale of each data center where software resources are currently aggregated and to place the data centers in a dispersed manner in sites that are geographically distant from one another for the purpose of reducing a delay in communication from a terminal to a server that provides software resources, increasing the available bandwidth that can be used for end-to-end communication between the terminal and the server, and diminishing the total volume of a traffic flow in a wide area network.

The data centers to be dispersed among far apart places are not limited to those that are dispersed in the related art, namely, data centers whose software resource providing servers are coupled to a terminal via a wide area network such as the Internet, which is made up of networks of Internet service providers (ISPs). The data centers to be dispersed are placed also in telecommunications carrier networks, which couple a terminal to the Internet, in local area networks (LANs), which are networks closer to terminals than to telecommunications carrier networks, and in other similar places. Data centers in the following description refer to data centers placed in a dispersed manner in sites that are geographically distant from one another.

In this invention, the location of a data center that provides software resources may vary depending on the combination of a terminal and an application program. It is also a possibility in this invention that the optimum data center may vary among a plurality of terminals that make inquiries to the same local DNS (LDNS). A data center optimum for a terminal is a data center that provides a software resource associated with the terminal and with an application program in question, and that is small in delay in communication from the terminal to a server providing the software resource, or that has a broad bandwidth that can be used for end-to-end communication between the terminal and the server, or that has an effect of greatly diminishing the volume of a traffic flow in a wide area network.

However, with the method of U.S. Pat. No. 7,441,045 B2, which uses name resolution, an IP address that is associated with a domain name is prescribed for each LDNS and, consequently, in the case where the optimum data center varies from one terminal to another because the terminals have different logical locations within a network, not all of terminals that make inquiries to the same LDNS receive in response the IP address of a server in a data center that is optimum for the terminal. Instead, the same IP address is sent in response to all of the terminals that have made inquiries to the same LDNS, or random IP addresses are notified to the terminals by the round robin function. In addition, it is a frequent occurrence in the architecture described above that a change in the logical location within a network of a terminal as a result of the terminal's travel of, for example, a few hundred meters, changes which data center is optimum for the terminal.

In U.S. Pat. No. 7,441,045 B2, however, even if an IP address registered in an LDNS is changed instantly, a terminal keeps an IP address that is received in response to an inquiry to an LDNS for a fixed period of time (usually a day or so) as a cache, and the destination IP address obtained by the terminal remains the same unless the terminal refreshes the cache and makes an inquiry to the LDNS again. Consequently, the terminal continues to couple to a server in a data center to which the terminal has been coupling after the terminal's travel makes the data center no longer optimum for the terminal.

Moreover, a data center in the architecture described above may switch the software resource providing server from one server to another for some reason such as the capacity of the data center.

In U.S. Pat. No. 7,441,045 B2, however, the destination IP address obtained by a terminal remains the same after a data center that provides software resources to the terminal is switched to another data center, unless the terminal makes an inquiry to the LDNS anew, for the same reason as the one in the case where the terminal travels. Consequently, the terminal continues to couple to a server in a data center to which the terminal has been coupling after a switch is made and the data center no longer provides software resources to the terminal, which means that the terminal cannot access software resources until the terminal makes an inquiry to the LDNS again.

In JP 2011-170718 A where the round robin function of DNSs is used, when the data center small in communication delay varies among a plurality of terminals that make inquiries to the same DNS, as in U.S. Pat. No. 7,441,045 B2, not all of the plurality of terminals receive in response the IP address of a server in a data center that is small in communication delay and, instead, random IP addresses are notified to the plurality of terminals by the round robin function. In addition, when a terminal travels and when a switch is made from one data center to another as the data center that provides software resources to a terminal, the terminal continues to couple to a server in a data center to which the terminal has been coupling before the travel or the switching.

JP 2011-250033 A is effective when every communication apparatus along a communication path can be set so that a switch to a communication path that leads to the standby server is made. However, JP 2011-250033 A is not applicable to the case where not all of the communication apparatus are compatible to the settings and the case where a network of another telecommunications carrier is involved. Accordingly, while applicable to local areas such as an area inside a data center, JP 2011-250033 A is difficult to apply to a wide area network, which is a mixture of networks of a plurality of telecommunications carriers and a mixture of various communication apparatus.

As described above, the related art has problems with coupling a terminal to a server that is optimum for a combination of the terminal and an application program in question in an architecture where servers for providing software resources to a wide area network are dispersed throughout the wide area network. The related art also has problems with coupling a terminal to an optimum server quickly when a switch is made from one server to another as the server that provides software resources to the terminal, when the terminal travels, or the like.

A representative aspect of the present disclosure is as follows. A communication path management method for setting a path through which a terminal accesses a server in a system, the system comprising servers coupled to a plurality of communication apparatus to provide software, terminals coupled to the plurality of communication apparatus to use the software, and a network for coupling the plurality of communication apparatus, the communication path management method comprising: a first step of assigning, by a management computer, which is coupled to the network to manage the plurality of communication apparatus and the servers, a combination of the terminals that share the same server as a server that provides the software to the terminals and software that is run by the terminals to a logical aggregation group; and a second step of setting, by the management computer, communication paths of the plurality of communication apparatus, on an aggregation group-by-aggregation group basis.

According to the one embodiment of this invention, in the case where servers for providing software resources that are used by users of terminals are dispersed throughout a network, a terminal can be coupled to a server that is optimum for a combination of the terminal and an application program in question while preventing an increase in terminal count or an increase in traffic volume from adding to the processing load on a network control server and the processing load on communication apparatus. This invention also enables a terminal to couple to an optimum server quickly when a switch is made from one server to another as the server that provides software resources to the terminal, when the terminal travels, or the like.

### BRIEF DESCRIPTION OF THE DRAWINGS

FIG. 1 is a block diagram for illustrating the configuration of a computing system in this embodiment of this invention.

FIG. 2A is a block diagrams for illustrating the function configuration of the network control server in this embodiment of this invention.

FIG. 2B is a block diagrams for illustrating the function configuration of the network control server in this embodiment of this invention.

FIG. 3 is a block diagram for illustrating an example of the servers in this embodiment of this invention.

FIG. 4 is an explanatory diagram of the aggregation group information table in this embodiment of this invention.

FIG. 5 is an explanatory diagram of the aggregation group switching cost information table in this embodiment of this invention.

FIG. 6 is an explanatory diagram of the aggregation group destination information table in this embodiment of this invention.

FIG. 7 is an explanatory diagram of the aggregation group destination changing information table in this embodiment of this invention.

FIG. 8 is an explanatory diagram of the inter-communication apparatus communication characteristics information table in this embodiment of this invention.

FIG. 9 is an explanatory diagram of the access point-communication apparatus communication characteristics information table in this embodiment of this invention.

FIG. 10 is an explanatory diagram of the demanded communication characteristics information table in this embodiment of this invention.

FIG. 11 is an explanatory diagram of the resource providing location information table in this embodiment of this invention.

FIG. 12 is an explanatory diagram of the name resolution information table in this embodiment of this invention.

FIG. 13 is an explanatory diagram of the settings information table in this embodiment of this invention.

FIG. 14A is a sequence diagram for illustrating processing that is executed in this embodiment of this invention.

FIG. 14B is a sequence diagram for illustrating processing that is executed in this embodiment of this invention.

FIG. 15 is a sequence diagram of processing in which the terminal makes a request to view or update a software resource in this embodiment of this invention.

FIG. 16 is a sequence diagram of processing in which the terminal makes a viewing request or an updating request to the server in this embodiment of this invention.

FIG. 17 is a sequence diagram of processing that is executed when a failure occurs between the communication apparatus and the server in this embodiment of this invention.

FIG. 18 is an explanatory diagram of processing in which, after traveling of the terminal that has been using the server to view or update information in this embodiment of this invention.

FIG. 19 is a flow chart for illustrating an example of processing in which the aggregation group determining module in this embodiment of this invention.

FIG. 20 is a flow chart for illustrating an example of processing in which the aggregation group address management module in this embodiment of this invention.

FIG. 21 is a flow chart for illustrating an example of processing in which the path/destination setting module 209 in this embodiment of this invention.

FIG. 22 is a flow chart for illustrating an example of processing in which the aggregation group address management module in this embodiment of this invention.

FIG. 23 is a flow chart for illustrating an example of processing in which the aggregation group address management module in this embodiment of this invention.

FIG. 24 is a flow chart for illustrating an example of processing in which the path/destination setting module 209 in this embodiment of this invention.

### DETAILED DESCRIPTION OF THE PREFERRED EMBODIMENTS

An embodiment of this invention is described below with reference to the accompanying drawings.

In this embodiment, terminals that share the same server identifier as the identifier of a server that provides software resources used by terminal users are combined with an application program, and the combination is managed as an aggregation group. Examples of software resources used by terminal users in the following description include virtual servers, application programs, data, storage areas (storage services), and other resources that can be used from a terminal. Software resources used by terminal users may also be virtual servers that are provided in the form of desktop-as-a-service (DaaS) or similar forms, application programs that are provided in the form of software-as-a-service (SaaS) or similar forms, and data. The server identifier is a unique identifier managed by a network control server (or network control apparatus) 100, unlike the IP address or other identifiers.

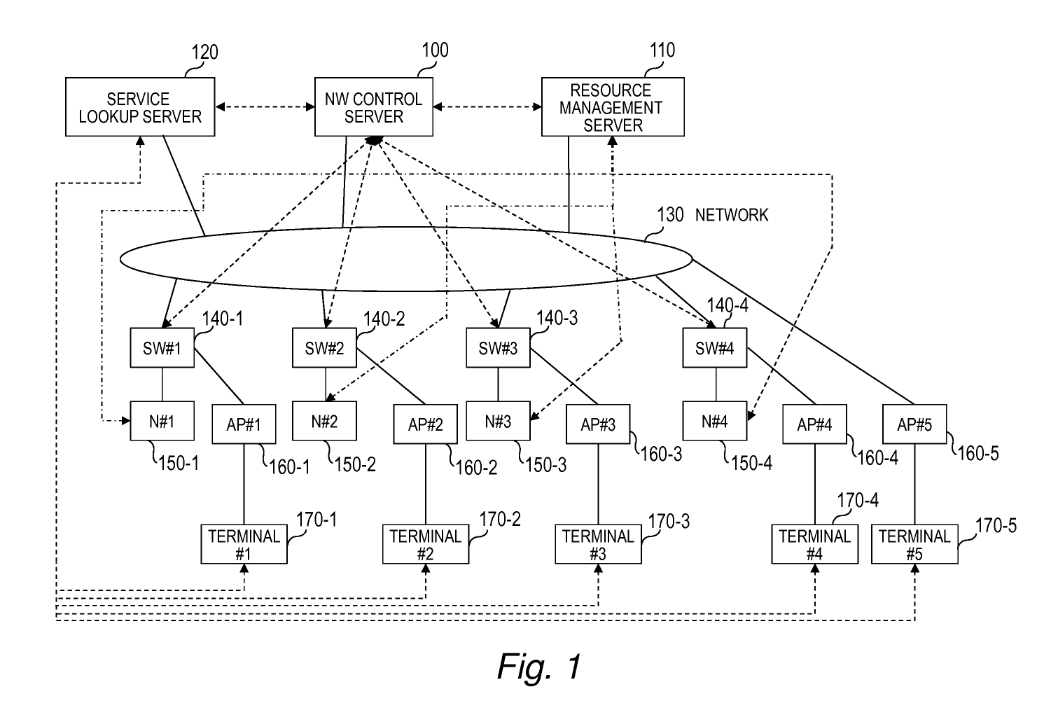

FIG. 1 is a block diagram for illustrating the configuration of a computing system in this embodiment.

The computing system of the embodiment of this invention includes the network control server 100, a resource management server 110, a service lookup server 120, a network 130, communication apparatus 140 (communication apparatus 140-1 to 140-n), servers 150 (servers 150-1 to 150-n), access points 160 (access points 160-1 to 160-n), and terminals 170 (170-1 to 170-n). The reference symbols of the terminals, the servers, and the communication apparatus have suffixes “-1” to “-n” when individual terminals, servers, and communication apparatus are to be identified, and do not have the suffixes when the terminals, the servers, and the communication apparatus are denoted collectively. The network control server 100, the resource management server 110, and the service lookup server 120 may be provided by a single management computer.

The network control server 100 is a computer for controlling traffic (or packets) that passes through the communication apparatus 140. The network control server 100 includes a management terminal for providing a screen display function and a system operation function to an administrator or other persons.

The network control server 100 is coupled to the plurality of communication apparatus 140, the resource management server 110, and the service lookup server 120. The network control server 100 sets communication paths to which the respective communication apparatus 140 are to be coupled. OpenFlow proposed in pages 6 to 21 of an online article titled “OpenFlow Switch Specification Version 1.3.0 (Wire Protocol 0x04)”, published on Jun. 25, 2012 by the Open Networking Foundation, and retrieved on Jul. 25, 2012, or in other technologies can be applied to the setting of the communication paths. The communication paths to which the communication apparatus 140 are to be coupled are set for each aggregation group described above, or for each combination of an application program and interrelated terminals.

The resource management server 110 is a computer for managing the servers 150 and resources that are provided by the servers 150. The resource management server 110 includes a management terminal (not shown) for providing a screen display function and a system operation function to the administrator or other persons.

The resource management server 110 is coupled to the plurality of servers 150, the network control server 100, and the service lookup server 120. The resource management server 110 calculates, for each server 150, software resources being provided by the server 150, manages the servers 150 providing software resources, and manages, for each combination of one terminal 170 and an application program, the server 150 to which the terminal 170 is coupled. Each terminal 170 is a computer that includes a processor, a memory, and a communication interface. Similarly, the resource management server 110 and the service lookup server 120 are each a computer that includes a processor, a memory, and a communication interface.

The service lookup server 120 is a computer for sending in response an optimum IP address for each combination of one terminal 170 and an application program. The service lookup server 120 includes a management terminal (not shown) for providing a screen display function and a system operation function to the administrator or other persons.

The service lookup server 120 is coupled to the terminal 170, the network control server 100, and the resource management server 110. In response to an IP address inquiry from one of the terminals 170, the service lookup server 120 sends to the terminal 170 an IP address that is associated with a domain name received from the terminal 170, by executing name resolution with the use of a combination of the received domain name, the identifier of the terminal 170, and the identifier of an application program. The identifier of each terminal 170 and the identifier of an application program are each a unique identifier that is uniquely assigned and managed by the service lookup server 120, the resource management server 110, and the network control server 100.

The network 130 is the Internet where routing is executed with the use of the IP address or a similar network, or, a wide area network configured based on a protocol that uses labels or tags to execute switching, such as Multiprotocol Label Switching (MPLS), QinQ, or Ethernet-over-Ethernet (EoE). The network 130 includes a plurality of network apparatus such as routers and switches, and cables or fibers that physically couple the network apparatus to one another. A network in this embodiment may also be a virtually implemented network.

The communication apparatus 140 are network apparatus managed by the network control server 100. The network apparatus as the communication apparatus 140 are built from routers or switches that refer to header information of packets in traffic, which are Layer 2 packets, Layer 3 packets, and Layer 4 packets in the TCP/IP reference model. The communication apparatus 140, under control of the network control server 100, transfers or discards the traffic and performs a header change or other types of processing on the Layer 2, Layer 3, or Layer 4 packets. The communication apparatus 140 of this embodiment may also be virtually implemented switches or routers.

The servers 150 are computers managed by the resource management server 110. The servers 150 provide software resources used by users of the terminals 170, receive information viewing requests and information updating requests issued from the terminals 170, and execute, in response, processing requested by the terminals 170.

The servers 150 that are associated with a combination of the terminal 170 and an application program that belong to the same aggregation group synchronize data with one another. This enables the servers 150 to respond to information viewing requests and information updating requests issued from the terminals 170 and execute processing requested by the terminals 170 also when one of the terminals 170 transmits an information viewing or updating request to an arbitrary server 150 that belongs to the same aggregation group as the terminal 170, or when the relevant communication apparatus 140 changes the traffic destination from one associated server 150 to another server 150 that is associated with a combination of the terminal 170 and an application program that belong to the same aggregation group. The servers 150 follow an instruction from the resource management server 110 when synchronizing data, an application program, or the like with one another. The servers 150 of this embodiment may also be virtually implemented servers.

The access points (AP in the drawings) 160 have a function of transmitting and receiving radio waves of WiFi, 3G, LTE, and the like, and a function of coupling to the network 130, which is a cable network, to transmit and receive traffic. The functions of the access points 160 include Network Address Translation (NAT) by which a local IP address and a global IP address are converted into each other, or Network Address and Port Translation (NAPT) by which one global IP address and a plurality of IP addresses are converted into each other.

The terminals 170 are computers such as cellular phones, smartphones, tablet terminals, and PCs. The terminals 170 couple to the communication apparatus 140, the service lookup server 120, and the network control server 100 via the access points 160.

The terminals 170 have a screen display function and a system operation function, thereby enabling users of the terminals 170 to update, delete, and view information about software resources that are provided by the servers 150. The terminals 170 may couple to the network 130 or the communication apparatus 140 without accessing the access points 160.

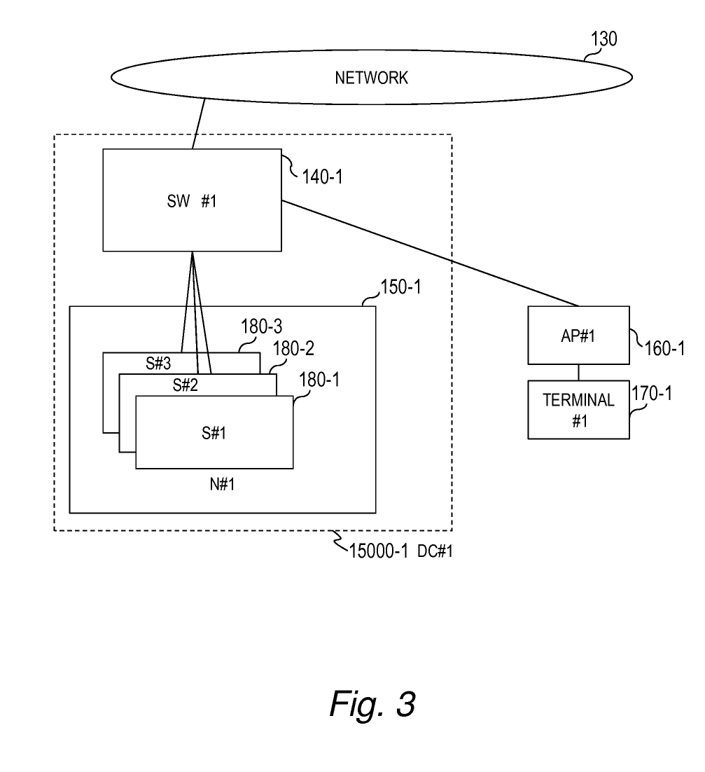

FIG. 3 is a block diagram for illustrating an example of the servers 150. Each server 150 may be a single computer or may be a plurality of computers as illustrated in FIG. 3, where computers 180-1 to 180-n are coupled to one of the communication apparatus 140, here, 140-1, and each computer 180 provides software resources used by users of the terminals 170. In this case, the component denoted by 150-1 functions as a node. The node 150-1 and the communication apparatus 140-1 can together function as a data center 1500-1. The computers 180 may be configured as virtual computers.

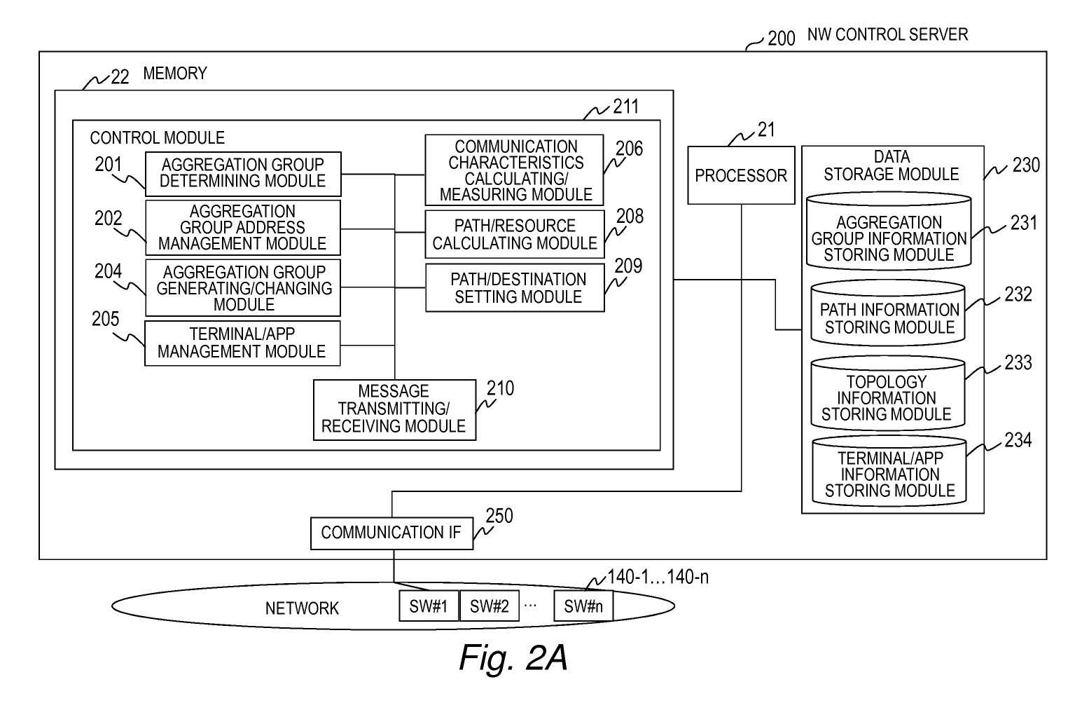

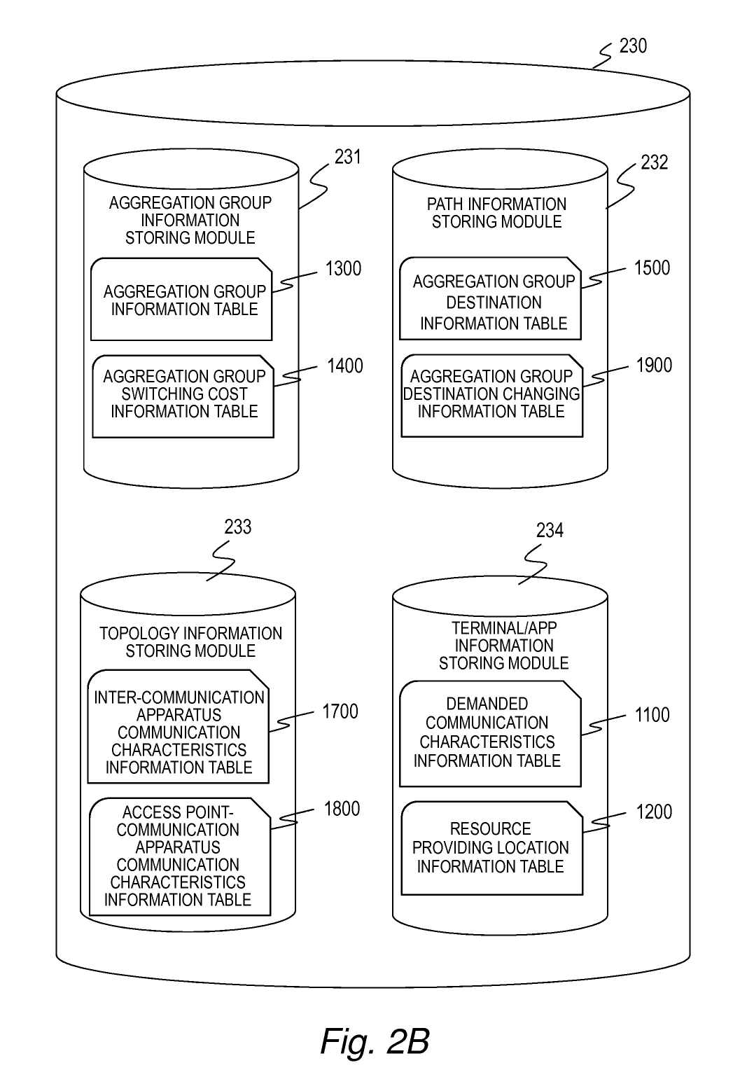

FIG. 2A and FIG. 2B are block diagrams for illustrating the function configuration of the network control server 100 in this embodiment. The block diagram of FIG. 2A is for illustrating a configuration example of the network control server 100. The block diagram of FIG. 2B is for illustrating a configuration example of a data storage module 230 of the network control server 100.

The network control server 100 includes a processor 21, a memory 22, a communication IF 250, the data storage module 230, and a control module 211.

The communication IF 250 sets, deletes, or changes communication paths in the communication apparatus 140 of the network 130 directly or via an element management system (EMS). The communication IF 250 also transmits to the communication apparatus 140 a message containing an instruction that instructs the communication apparatus 140 to transmit information that the communication apparatus 140 hold. The communication IF 250 receives from the communication apparatus 140 messages containing the information.

The data storage module 230 stores values that are referred to or updated by the control module 211. The data storage module 230 is built in a non-volatile storage apparatus or the like that is included in the network control server 100.

The data storage module 230 includes an aggregation group information storing module 231, a path information storing module 232, a topology information storing module 233, and a terminal/app information storing module 234. Information held in the data storage module 230 is described below.

The aggregation group information storing module 231 is a storage module configured to hold information of a group in which combinations of one terminal 170 and an application program that have similar (or matching) characteristics are grouped together.

Having similar characteristics means having the same server identifier as the identifier of the server 150 that provides software resources to the terminal 170, or having the same server identifier as the identifier of the server 150 that provides software resources to the terminal 170 and being equivalent to each other in communication delay, priority, and other communication characteristics demanded by the terminal 170. For example, when the communication delay is equal to or less than a threshold (e.g., 30 milliseconds) and the bandwidth is equal to or more than a threshold (e.g., 200 megabits per second) out of communication characteristics information, it is determined that the characteristics are similar.

The aggregation group information storing module 231 holds as illustrated in FIG. 2B an aggregation group information table 1300 and an aggregation group switching cost information table 1400, which are described later.

The path information storing module 232 is a storage module configured to hold, for each aggregation group, or for each combination of a user and an application program, information of a destination and a communication path that are set in the relevant communication apparatus 140.

The path information storing module 232 holds as illustrated in FIG. 2B an aggregation group destination information table 1500 and an aggregation group destination changing information table 1900, which are described later.

The topology information storing module 233 is a storage module configured to hold information about communication delay and other communication characteristics in communication between the communication apparatus 140, and information about communication characteristics in communication between the access points 160 and the communication apparatus 140.

The topology information storing module 233 holds as illustrated in FIG. 2B an inter-communication apparatus communication characteristics information table 1700 and an access point-communication apparatus communication characteristics information table 1800, which are described later.

The terminal/app information storing module 234 is a storage module configured to hold, for each combination of one terminal 170 and an application program, communication characteristics that are demanded by the terminal 170 and to hold, for each combination of one terminal 170 and an application program, the identifier of a server that provides software resources to the terminal 170 and the like.

The terminal/app information storing module 234 holds a demanded communication characteristics information table 1100 and a resource providing location information table 1200, which are described later.

The control module 211 refers to values of the tables held in the data storage module 230 and determines, for each combination of one terminal 170 and an application program, an aggregation group that is associated with the combination. The control module 211 then determines whether or not it is necessary to set settings in the relevant communication apparatus 140. When determining that the communication apparatus 140 needs to be set, the control module 211 calculates the destination, the communication path, the bandwidth, and the like, and gives an instruction containing the calculated settings to the communication apparatus 140. The control module 211 also receives from the resource management server 110 information such as demanded communication characteristics and a software resource providing location. The bandwidth can be one of actually measured value and theoretical value that is selected suitably.

The control module 211 transmits information to the resource management server 110, which includes, among others, a combination of the identifiers of servers that can provide software resources, and the switching of a server to which a terminal is coupled. The control module 211 transmits a combination of a domain name and an IP address to the service lookup server 120.

The control module 211 includes functions illustrated in FIG. 2A, which are an aggregation group determining module 201, an aggregation group address management module 202, an aggregation group generating/changing module 204, a terminal/app management module 205, a communication characteristics calculating/measuring module 206, a path/resource calculating module 208, and a path/destination setting module 209.

The aggregation group determining module 201 is a function for determining an aggregation group for each combination of one terminal 170 and an application program, based on demanded communication characteristics information and the like.

The aggregation group address management module 202 includes a function of generating, for each communication apparatus 140, address information of a transmission destination and a transmission source that are associated with an aggregation group.

The aggregation group generating/changing module 204 is a function of generating a new aggregation group, or changing or deleting the address or the like of an existing aggregation group.

The terminal/app management module 205 is a function of generating or deleting the address of a combination of one terminal 170 and an application program when the aggregation group to which the combination of the terminal 170 and the application program belongs is switched from one group to another.

The communication characteristics calculating/measuring module 206 is a function of measuring or calculating communication characteristics such as communication delay in communication between communication apparatus 140 and between the access points 160 and the communication apparatus 140.

The path/resource calculating module 208 has a function of calculating for each communication apparatus 140 a port through which the communication apparatus 140 transfers traffic and, in the case where the network 130 to which the communication apparatus 140 are coupled is a network that allows for the reservation of a bandwidth, such as a Multiprotocol Label Switching (MPLS) network or a Multiprotocol Label Switching Transport Profile (MPLS-TP) network, a function of calculating a bandwidth.

The path/destination setting module 209 sets, in the communication apparatus 140, the transfer or discarding of traffic, a change to the header of a Layer 2, Layer 3, or Layer 4 packet, or other settings.

A message transmitting/receiving module 210 creates a message based on data that is generated by the path/destination setting module 209, and transmits the message to the relevant node 150 via the communication IF 250. The message is for setting settings that are necessary to execute such processing as the transfer or discarding of traffic, or a change to the header of a Layer 2, Layer 3, or Layer 4 packet, for changing the settings, or for deleting the settings.

When the communication IF 250 collects messages about information of the communication apparatus 140 from the communication apparatus 140, the message transmitting/receiving module 210 interprets the collected messages and transmits the messages to the communication characteristics calculating/measuring module 206, the aggregation group determining module 201, and the path/resource calculating module 208.

The message transmitting/receiving module 210 receives from the resource management server 110 information such as demanded communication characteristics and a software resource providing location, and transmits to the resource management server 110 information such as a combination of the identifiers of servers that can provide software resources, and the switching of a server to which one terminal 170 is coupled.

The message transmitting/receiving module 210 transmits a combination of a domain name and an IP address to the service lookup server 120.

The function modules of the control module 211 are loaded as programs onto the memory 22. The processor 21 operates as programmed by the respective programs of the function modules, to thereby operate as function modules that implement given functions. For example, the processor 21 functions as the aggregation group determining module 201 by operating as programmed by an aggregation group determining program. The same applies to the rest of the programs. The processor 21 also operates as a function module that implements a plurality of processing procedures executed by each program. A computer and a computer system are an apparatus and a system that include those function modules.

The programs that implement the functions of the control module 211, the tables, and other types of information can be stored in the data storage module 203, a non-volatile semiconductor memory, a storage device such as a hard disk drive or a solid state drive (SSD), or a computer-readable, non-transitory data storage medium such as an ID card, an SD card, or a DVD.

<Data Storage Module>

Information managed by the data storage module 230 in this embodiment is described below.

<Aggregation Group Information Storing Module 231>

The aggregation group information table 1300 and the aggregation group switching cost information table 1400, which are managed by the aggregation group information storing module 231 as illustrated in FIG. 2B, are described first.

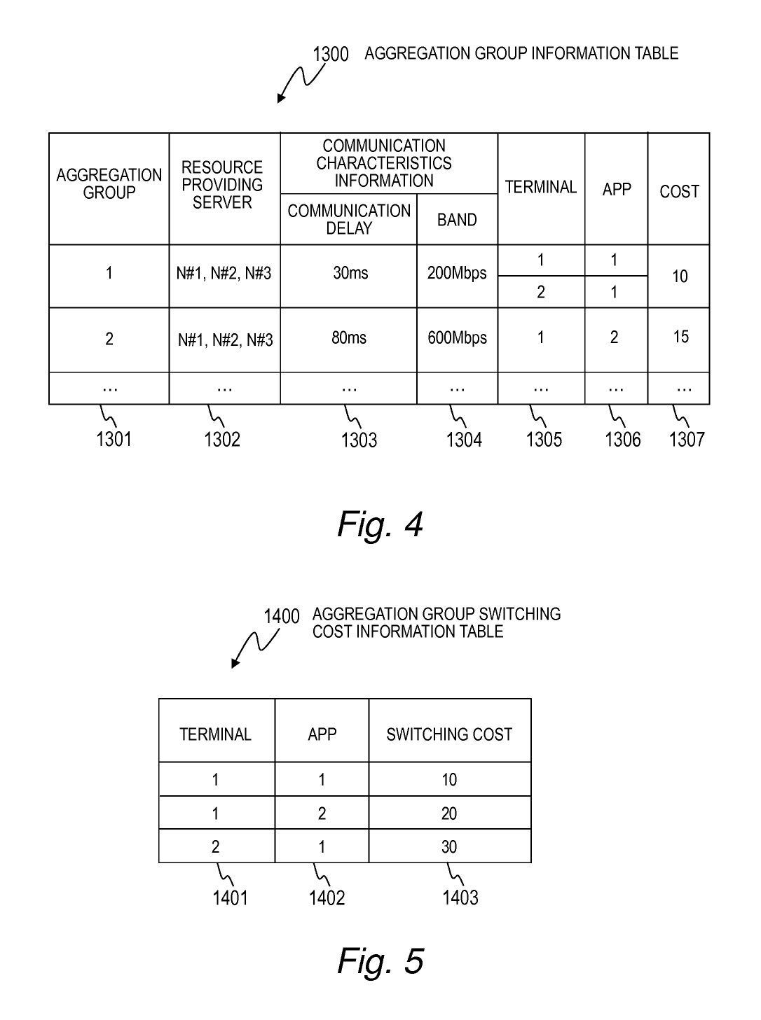

FIG. 4 is an explanatory diagram of the aggregation group information table 1300.

In the aggregation group information table 1300, an aggregation group 1301, a resource providing server 1302, communication characteristics information 1303, communication characteristics information 1304, a terminal 1305, an app 1306, and a cost 1307 constitute each single record entry.

The aggregation group 1301 indicates the identifier of an aggregation group, and is used to group together and manage a combination of an application program and the terminals 170 that have the same software resource providing location and similar communication characteristics information. The software resource providing location is described later.

Stored as the resource providing server 1302 is the identifier of the server 150 that provides software resources. The server identifier is, for example, a domain name. The communication characteristics information 1303 and the communication characteristics information 1304 indicate communication characteristics in communication between the servers 150 that belong to an aggregation group, and are classified into a communication delay 1303 and a bandwidth 1304. The communication delay 1303 indicates a round trip time (RTT) between the servers 150. In the case where three or more servers 150 are included in the aggregation group, the communication delay 1303 indicates the maximum RTT value among the RTT between every two servers 150. The bandwidth 1304 indicates the volume (bit rate) of a traffic flow that can pass between the servers 150. In the case where three or more servers 150 are included in the aggregation group, the bandwidth 1304 indicates the minimum bandwidth value among the bandwidth between every two servers 150.

The terminal 1305 indicates an identifier for uniquely identifying a computer such as a cellular phone, a smartphone, a tablet, or a PC. The terminal identifier is a value unique to each terminal 170 that is determined by the resource management server 110 or other components, and is an invariable value that is not changed by the traveling, rebooting, or the like of the terminal 170. The app 1306 indicates the identifier of an application program, which is a value unique to the application program and determined by the resource management server 110 or other components. The cost 1307 is one of indices for selecting an aggregation group, and indicates an economic burden that is incurred by the use of a particular aggregation group. Specifically, the cost 1307 includes a cost entailed in using a processor and a memory of the relevant server 150 and storage, and a cost entailed in using the bandwidth of a network between the relevant servers 150.

An example of the method of calculating a cost C is given below in the form of Expression (1).

C=Cs+Cn (1)

The cost C is calculated as the sum of a cost Cs, which is the cost of the relevant server 150 and storage, and a cost Cn, which is a network cost.

The cost Cs on the server 150 side, which includes the server 150 and storage (the data storage module 230), is calculated by Expression (2).

$$Cs = α \frac{A}{{A}^{′} - A} + β \frac{B}{{B}^{′} - B} + γ \frac{D}{{D}^{′} - D} \qquad ( 2 )$$

In Expression (2), A and A′ represent the current CPU usage and the total CPU capacity, respectively, B and B′ represent the main memory usage and the total main memory capacity, respectively, D and D′ represent the disk storage usage and the total disk storage capacity, respectively, and α, β, and γ each represent a given coefficient between 0 and 1.

The method of calculating the network cost Cn is expressed by Expression (3). Discussed here is a case where the network includes an active path and a backup path. When a backup path is included, a cost for the active path alone can be calculated by setting a coefficient that is related to the backup path to 0.

The cost Cn is calculated as follows:

Cn=av+bw+cx+dy+ez (3)

In Expression (3), a and v constitute a term concerning the presence or absence of an available bandwidth, b and w constitute a term concerning a delay restriction, c and x constitute a term concerning disjointing, d and y constitute a term concerning effective bandwidth utilization, and e and z constitute a term concerning load balancing. Disjointing is to avoid disconnection due to a single failure by prohibiting the active path and the backup path from sharing the same link. The symbols a, b, c, d, and e represent weighting factors, and v, w, x, y, and z represent functions calculated by Expression (4) to Expression (6).

In the following expressions, l represents a link, bl and r represent an available bandwidth of the link l and a contract bandwidth of the link l, respectively, and da, db, and d′ represent a delay along the active path, a delay along the backup path, and a delay restriction, respectively. The symbol mₗ represents a metric of the link l, and an exponential algorithm for enabling a link to accommodate many paths or other algorithms can be used for the metric mₗ.

The metric mₗ is calculated in the exponential algorithm as a function that represents the proportion of the available bandwidth of the link l to a physical bandwidth. The symbols La and Lb represent a group of links that constitute the active path and a group of links that constitute the backup path, respectively. A necessary and sufficient condition for a path to be selected as one that fulfills requirements regarding the presence or absence of an available bandwidth, a delay restriction, and the disjointing constraint is that the cost Cn satisfy Expression (7).

$$\begin{matrix}{x}_{1} = \{ \begin{matrix}0 , & if & {b}_{l , t , v} > r & for all l ∈ ( La ⋃ Lb ) \\ 1 , & if & {b}_{l , t , v} \leq r & for an l ∈ ( La ⋃ Lb )\end{matrix} & ( 4 ) \\ {x}_{2} = \{ \begin{matrix}0 , & if & {d}_{a} < {d}^{′} , \& {d}_{b} < {d}^{′} \\ 1 , & if & {d}_{a} \geq {d}^{′} , or {d}_{b} \geq {d}^{′}\end{matrix} & ( 5 ) \\ {x}_{3} = \{ \begin{matrix}1 , & if & active path and backup path \\ & pass & through the same links \\ 0 , & if & not \end{matrix} & ( 6 ) \\ {x}_{4} = {\sum }_{l}^{La} {m}_{l} + {\sum }_{l}^{Lb} {m}_{l} & ( 7 ) \\ {γ}_{k} > c , for all k = 1 , 2 , 3 , & ( 8 )\end{matrix}$$

In this manner, loads can be balanced while keeping within the delay restriction and the disjointing constraint, and bypassing a link that is small in available bandwidth.

The aggregation group information table 1300 enables the network control server 100 to group together and manage a combination of an application program and the terminals 170 that have the same server providing location and similar communication characteristics information. The network control server 100 transmits a settings message to each communication apparatus 140 on an aggregation group-by-aggregation group basis, thereby cutting the quantity of settings messages. The network control server 100 can consequently lighten the load on the CPUs and memories of the communication apparatus 140.

The aggregation group information table 1300 where the servers 150 and communication characteristics information are both managed also enables the network control server 100 to determine, for each combination of one terminal 170 and an application program, an aggregation group to which the combination of the terminal 170 and an application program belongs while taking necessary communication characteristics into consideration, by checking against the demanded communication characteristics information table 1100, which is described later.

The aggregation group information table 1300 where cost is managed on an aggregation group-by-aggregation group basis while taking an economic burden into consideration further enables the network control server 100 to determine an aggregation group that is best suited for a combination of one terminal 170 and an application program. In addition, the network control server 100 can balance loads by dynamically changing the cost value C.

FIG. 5 is an explanatory diagram of the aggregation group switching cost information table 1400.

In the aggregation group switching cost information table 1400, a terminal 1401, an app 1402, and a switching cost 1403 constitute each record entry.

The switching cost 1403 indicates a load, or an economic burden, that is incurred on the network 130 and a server by switching from one server 150 to another as the server that provides software resources. The switching cost 1403 has a positive correlation with a stored data amount in the demanded communication characteristics information table 1100 described later. For example, the switching cost 1403 is low in the case of a combination of one terminal 170 and an application program that is small in stored data amount because the amount of data that is transferred in the course of a switch between the servers 150 is small. The network control server 100 determines, for example, frequent switching of aggregation groups for a combination of one terminal 170 and an application program that is small in switching cost. In this manner, overload due to a switch between aggregation groups is avoided by choosing, for an application program that is small in stored data amount such as a video game, frequent switching of aggregation groups so that the terminal 170 that is traveling is quickly switched to an aggregation group that is small in communication delay, and by not switching aggregation groups frequently for an application program that is large in stored data amount such as a video distribution program.

An example of the method of calculating a switching cost Cm is given in the form of Expression (9).

$${C}_{m} = {Σ}_{i = 0}^{N} {δ}_{i} \frac{{A}_{i}}{{b}_{i}} \qquad ( 9 )$$

In Expression (9), N represents a set of servers i whose data is migrated when a switch between aggregation groups takes place, Ai represents the amount of migrated data of a server i, bi represents a bandwidth that can be used by a path along which data of the server i to be switched is migrated, and Si represents a given coefficient between 0 and 1.

<Path Information Storing Module 232>

An aggregation group destination information table 1500 and the aggregation group destination changing information table 1900, which are managed by the path information storing module 232, are described next.

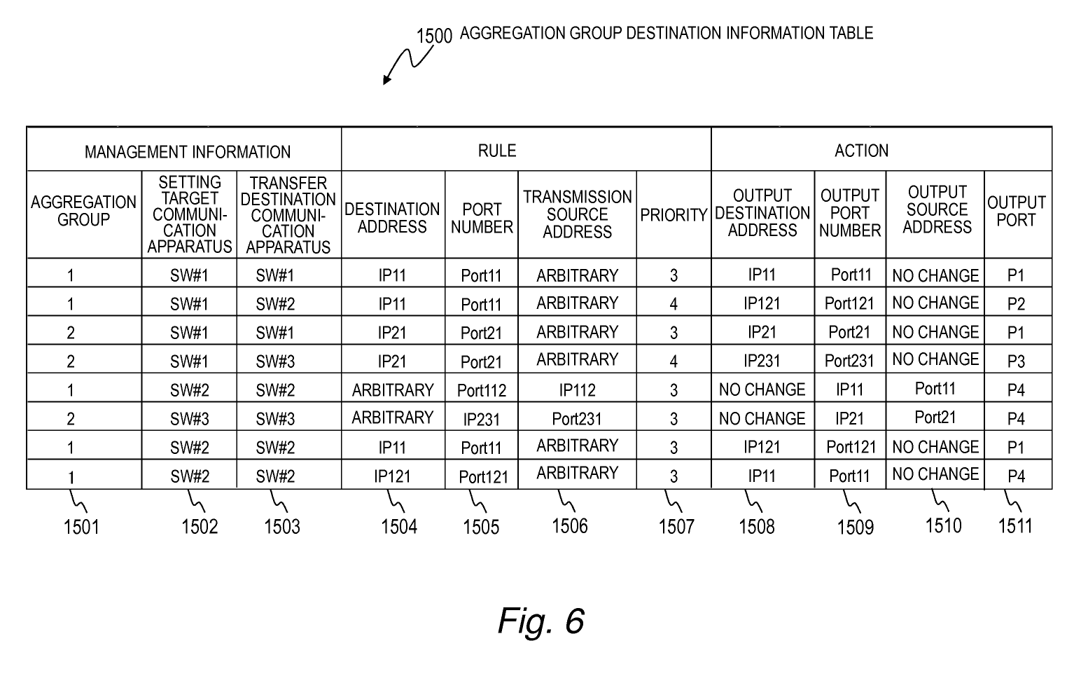

FIG. 6 is an explanatory diagram of the aggregation group destination information table 1500.

In the aggregation group destination information table 1500, management information 1501 to management information 1503, rules 1504 to 1507, and actions 1508 to 1511 constitute each single record entry.

The management information 1501 to the management information 1503 include an aggregation group 1501, a setting target communication apparatus 1502, and a transfer destination communication apparatus 1503. Stored as the aggregation group 1501 is the identifier of a group in which the terminals 170 that have the same access destination server 150 and the same application program (TCP port number) are grouped together. The setting target communication apparatus 1502 indicates the identifier of the communication apparatus 140 in which rules and actions are to be set. The communication apparatus identifier is, for example, an IP address for operational management. The transfer destination communication apparatus 1503 indicates the identifier of the communication apparatus 140 to which traffic flowing into the setting target communication apparatus 1502 is transferred.

The rules 1504 to 1507 are conditions for determining a processing method for traffic that flows into the setting target communication apparatus 1502. The rules 1504 to 1507 include a destination address 1504, a port number 1505, a transmission source address 1506, and a priority 1507.

The destination address 1504 indicates an IP address that is the destination of the received traffic. The port number 1505 indicates the TCP port number or UDP port number of the received traffic and identifies an application program. The port number 1505 includes one or both of a destination port number and a sender port number. The transmission source address 1506 indicates an IP address from which the received traffic has been transmitted. The priority 1507 indicates a priority level that is used by the setting target communication apparatus 1502 to determine which processing is to be executed when the traffic meets a plurality of conditions.

The actions 1508 to 1511 are processing methods that are executed for traffic flowing into the setting target communication apparatus 1502. The actions 1508 to 1511 include an output destination address 1508, an output port number 1509, an output source address 1510, and an output port 1511. The output destination address 1508 indicates a traffic destination IP address that is set when the traffic input to the setting target communication apparatus 1502 is to be transferred to another server 150. In the case where the output destination address 1508 in one row differs from the destination address 1504 in the same row, it means that the traffic destination IP address is to be changed.

The output port number 1509 indicates the port number of a TCP port or UDP port of the traffic that is set when, similarly to the output destination address 1508, the traffic is to be transferred. The output source address 1510 indicates a traffic transmission source address that is set when, similarly to the output destination address 1508, the incoming traffic at the setting target is to be transferred. The output port 1511 indicates the identifier of a port from which the traffic to be transferred is transmitted by the communication apparatus 140 that is the setting target. The port from which the traffic is output is identified out of a plurality of ports that the communication apparatus 140 has.

By managing as an aggregation group a combination of an application program and the terminals 170 that have the same server 150 as a software resource providing server, rules and actions can be prescribed based on the server IP address in the aggregation group destination information table 1500, instead of on the IP addresses of the terminals 170. This enables the network control server 100 to reduce the quantity of messages transmitted to the setting target communication apparatus 1502 from when rules and actions are prescribed for the IP address of each terminal 170, which adds up to a large number of IP addresses. The processing load on the network control server 100 is lightened as a result.

This also makes the number of IP addresses held in the setting target communication apparatus 1502 smaller than when rules and actions are prescribed for the IP address of each terminal 170, which adds up to a large number of IP addresses, and accordingly reduces the table size. A processing load that is incurred when the setting target communication apparatus 1502 executes processing of transferring or discarding the traffic is therefore lessened.

Further, in view of the fact that IP addresses and port numbers are finite and that IP addresses are being used up in IPv4, in particular, prescribing rules and actions for each aggregation group, instead of for each combination of one terminal 170 and an application program, keeps the number of IP addresses used and the number of port numbers used from swelling.

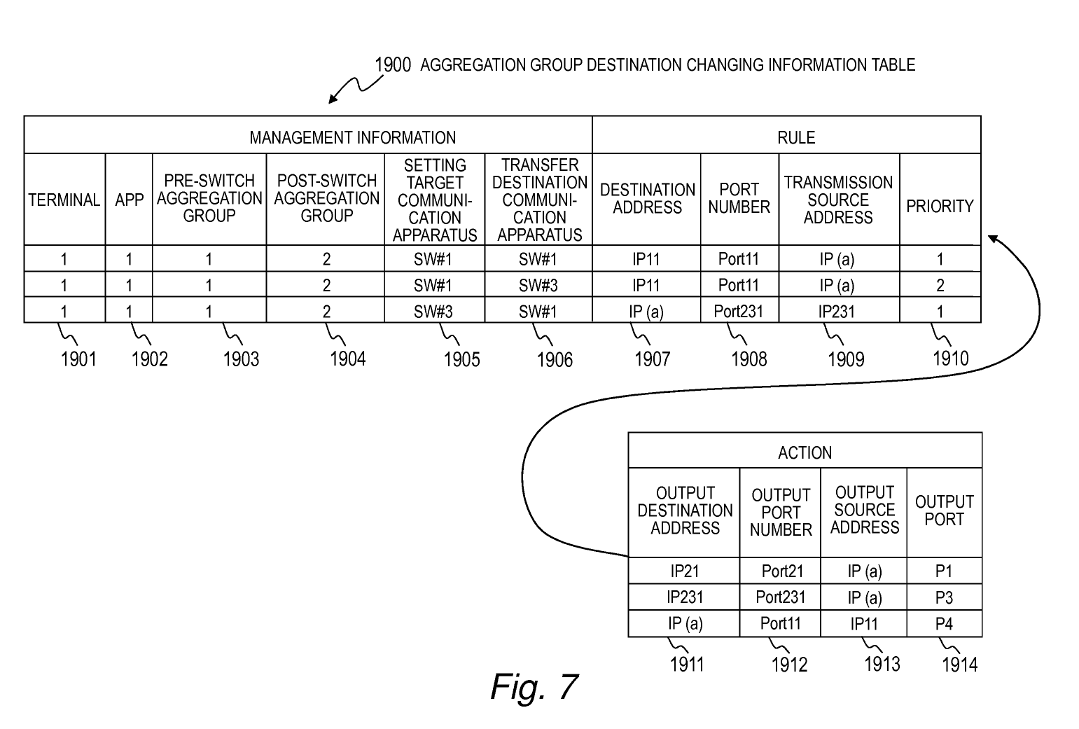

FIG. 7 is an explanatory diagram of the aggregation group destination changing information table 1900.

The aggregation group destination changing information table 1900 is information for managing a combination of one terminal 170 and an application program that has switched the aggregation group to which the combination belongs as a result of the switching of the server 150 that provides software resources to the terminal 170, and for managing different actions from those of the prior aggregation group of the combination.

In the aggregation group destination changing information table 1900, management information 1901 to management information 1906, rules 1907 to 1910, and actions 1911 to 1914 constitute each single record entry. The management information 1901 to management information 1906 include a terminal 1901, an app 1902, a pre-switch aggregation group 1903, a post-switch aggregation group 1904, a setting target communication apparatus 1905, and a transfer destination communication apparatus 1906. The pre-switch aggregation group 1903 indicates the identifier of an aggregation group to which a combination of one terminal 170 and an application program has belonged prior to the migration of software resources. The post-switch aggregation group 1904 indicates the identifier of an aggregation group to which the combination of the terminal 170 and an application program belongs after the migration of software resources.

The rules 1907 to 1910 and the actions 1911 to 1914 are the same as the rules 1504 to 1507 and the actions 1508 to 1511 in the aggregation group destination information table 1500.

Each communication apparatus 140 determines a processing method for traffic basically from the IP address and port number of the destination or transmission source server, instead of the IP address of the relevant terminal 170. However, when one terminal 170 switches aggregation groups as a result of the migration of software resources to another server 150, the IP address of traffic transmitted by the terminal 170 remains the IP address of the server that belongs to the previous aggregation group, until the terminal 170 makes an inquiry to the service lookup server 120 and changes the transmission source IP address. The terminal 170 therefore cannot couple to the server 150 that provides software resources until making an inquiry to the service lookup server 120.

The aggregation group destination changing information table 1900 enables the network control server 100 to set, in the communication apparatus 140 that is indicated by the setting target communication apparatus 1905, in association with the combination of an application program and the terminal 170 that has switched aggregation groups, actions different from those prescribed in the aggregation group destination information table 1500, based on the IP address and port number of the terminal 170 for a fixed period of time.

In this manner, the network control server 100 can set the communication apparatus 140 so that traffic from the terminal 170 is transferred to the switched-to server 150 after the switching of the server 150 that provides software resources to the terminal 170 until the terminal 170 makes a service lookup inquiry to the service lookup server 120, by sending an instruction to the communication apparatus 140 to switch communication paths based on the IP address of the terminal 170 until the terminal 170 executes the service lookup.

<Topology Information Storing Module 233>

The inter-communication apparatus communication characteristics information table 1700 and the access point-communication apparatus communication characteristics information table 1800, which are managed by the topology information storing module 233, are described next.

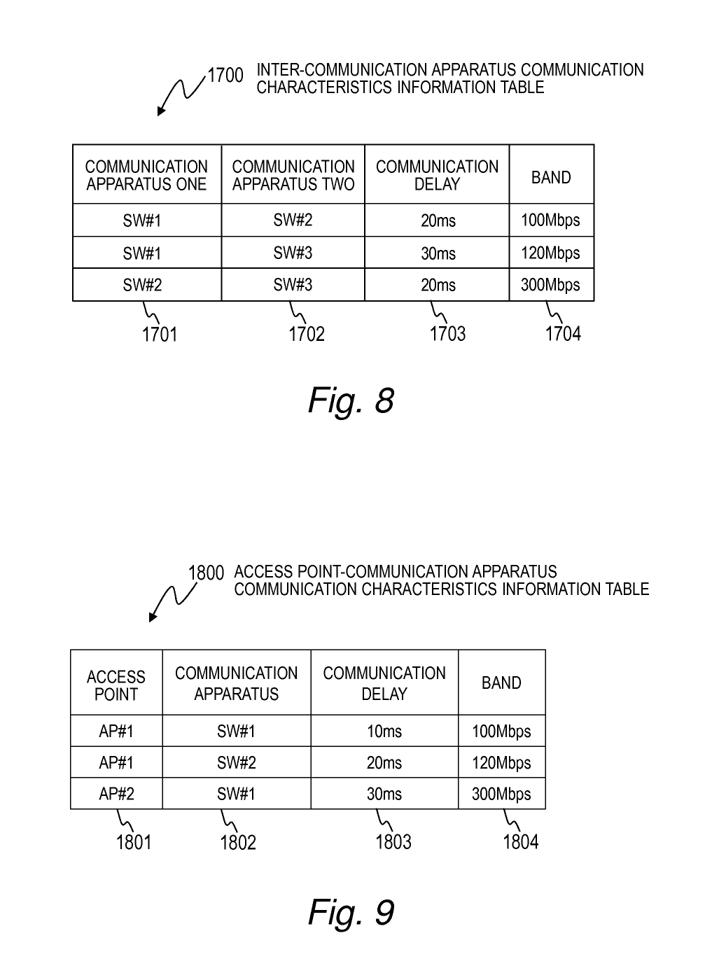

FIG. 8 is an explanatory diagram of the inter-communication apparatus communication characteristics information table 1700. The inter-communication apparatus communication characteristics information table 1700 indicates the characteristics of communication between the communication apparatus 140, which are measured or calculated by the path/resource calculating module 208. In the inter-communication apparatus communication characteristics information table 1700, Communication Apparatus One (1701), Communication Apparatus Two (1702), a communication delay 1703, and a bandwidth 1704 constitute each single record entry. Communication Apparatus One (1701) and Communication Apparatus Two (1702) each indicate the identifier of one communication apparatus 140.

The communication delay 1703 indicates an RTT between Communication Apparatus One and Communication Apparatus Two. The bandwidth 1704 indicates the volume (bit rate) of a traffic flow that can pass between Communication Apparatus One and Communication Apparatus Two.

The communication delay 1703 and the bandwidth 1704 of the inter-communication apparatus communication characteristics information table 1700 can be measured by using the Internet Control Message Protocol (ICMP) or the like between the communication apparatus 140, or between the servers 150 that couple to the communication apparatus 140. The RTT used is a value set in advance out of measurement values, such as a minimum measurement value or an average measurement value. The bit rate used is a value set in advance out of an actually measured value, an average value, and a theoretical value.

FIG. 9 is an explanatory diagram of the access point-communication apparatus communication characteristics information table 1800. The access point-communication apparatus communication characteristics information table 1800 indicates the characteristics of communication between an access point and one communication apparatus 140, which are measured or calculated by the path/resource calculating module 208.

In the access point-communication apparatus communication characteristics information table 1800, an access point 1801, a communication apparatus 1802, a communication delay 1803, and a bandwidth 1804 constitute each single record entry. The access point 1801 indicates the identifier of one of the access points 160. The communication delay 1803 indicates an RTT between the access point 160 indicated by the communication apparatus 1802 and the communication apparatus 140 indicated by the communication apparatus 1802. The bandwidth 1804 indicates the volume (bit rate) of a traffic flow that can pass between the access point 160 and the communication apparatus 140.

The communication delay 1803 and the bandwidth 1804 of the access point-communication apparatus communication characteristics information table 1800 can be measured by using the Internet Control Message Protocol (ICMP) or the like between the communication apparatus 140 and the access point 160 in question, or between the server 150 coupled to the communication apparatus 140 and the server 150 coupled to the access point 160. The RTT used is a value set in advance out of measurement values, such as a minimum measurement value or an average measurement value. The bit rate used is a value set in advance out of an actually measured value, an average value, and a theoretical value.

The inter-communication apparatus communication characteristics information table 1700, the access point-communication apparatus communication characteristics information table 1800, and a demanded delay and an access point 1113 of the demanded communication characteristics information table 1100, which is described later, enable the network control server 100 to select, for each combination of an application program and the terminals 170, the communication apparatus 140 that fulfills the demanded delay, or candidates for that communication apparatus 140.

<Terminal/App Information Storing Module 234>

The demanded communication characteristics information table 1100 and the resource providing location information table 1200, which are managed by the terminal/app information storing module 234, are described next.

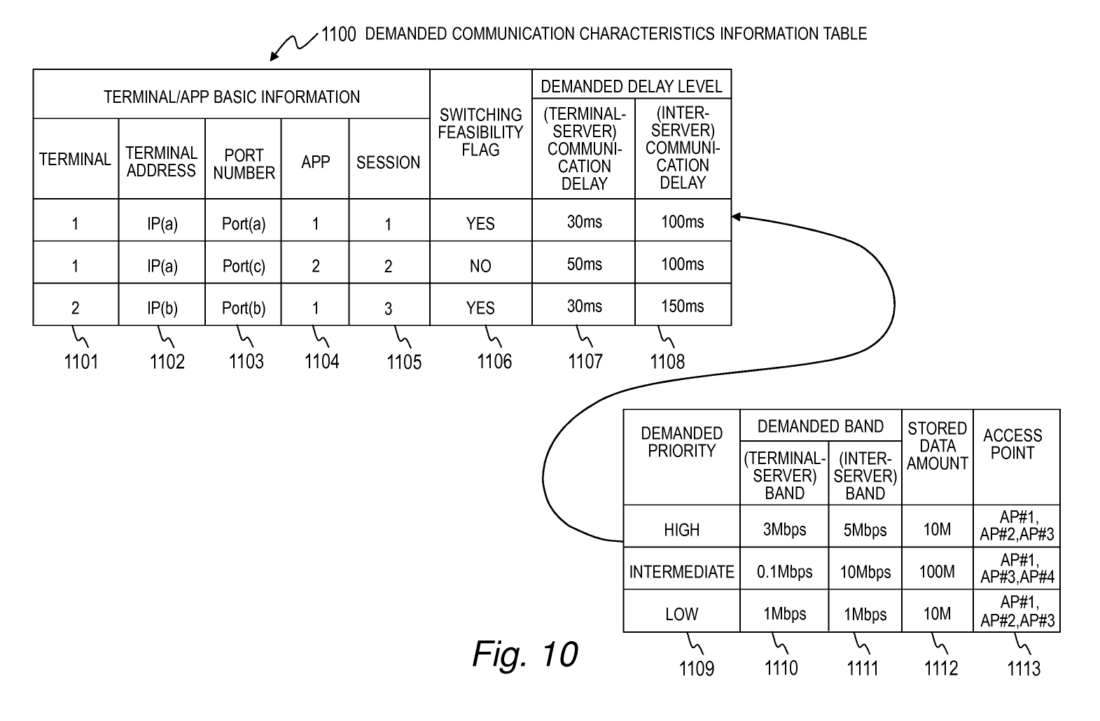

FIG. 10 is an explanatory diagram of the demanded communication characteristics information table 1100. The demanded communication characteristics information table 1100 indicates information about a combination of one terminal 170 and an application program, and is used to determine to which aggregation group a combination of one terminal 170 and an application program is to belong.

In the demanded communication characteristics information table 1100, terminal/app basic information 1101 to terminal/app basic information 1105, a switching feasibility flag 1106, demanded delays 1107 and 1108, a demanded priority 1109, demanded bandwidths 1110 and 1111, a stored data amount 1112, and the access point 1113 constitute each single record entry.

The terminal/app basic information 1101 to the terminal/app basic information 1105 include a terminal 1101, a terminal address 1102, a port number 1103, an app 1104, and a session 1105. The terminal 1101 indicates the identifier of one terminal 170. The terminal address 1102 indicates the IP address of the terminal 170. The port number 1103 indicates the TCP port number or UDP port number of traffic transmitted from the terminal 170. The session 1105 indicates a session that is held for each combination of the terminal 170 and an application program, for example, a cookie.

The switching feasibility flag 1106 indicates whether or not the relevant communication apparatus 140 is allowed to switch the destination to another server 150 that belongs to the same aggregation group.

The demanded delays 1107 and 1108 include a (terminal-server) communication delay 1107 and an (inter-server) communication delay 1108. The (terminal-server) communication delay 1107 indicates a threshold for a communication delay that is demanded between the relevant access point 160 and the relevant server 150, and means that a value equal to or less than the threshold is demanded. The (inter-server) communication delay 1108 indicates a threshold for a communication delay that is demanded between the relevant servers 150, and means that a value equal to or less than the threshold is demanded. Stored as the demanded priority 1109 is a level of priority to be reached when QoS is practiced.

The demanded bandwidths 1110 and 1111 include a (terminal-server) bandwidth 1110 and an (inter-server) bandwidth 1111. The (terminal-server) bandwidth 1110 indicates a threshold for a bandwidth that is demanded between the relevant access point 160 and the relevant server 150, and means that a value equal to or more than the threshold is demanded. The (inter-server) bandwidth 1111 indicates a threshold for a bandwidth that is demanded between the relevant servers 150, and means that a value equal to or more than the threshold is demanded.

The stored data amount 1112 indicates the amount (bytes) of data stored in the relevant server 150. The access point 1113 indicates the identifier of the access point 160 to which the combination of the terminal 170 and an application program in question is coupled most often.

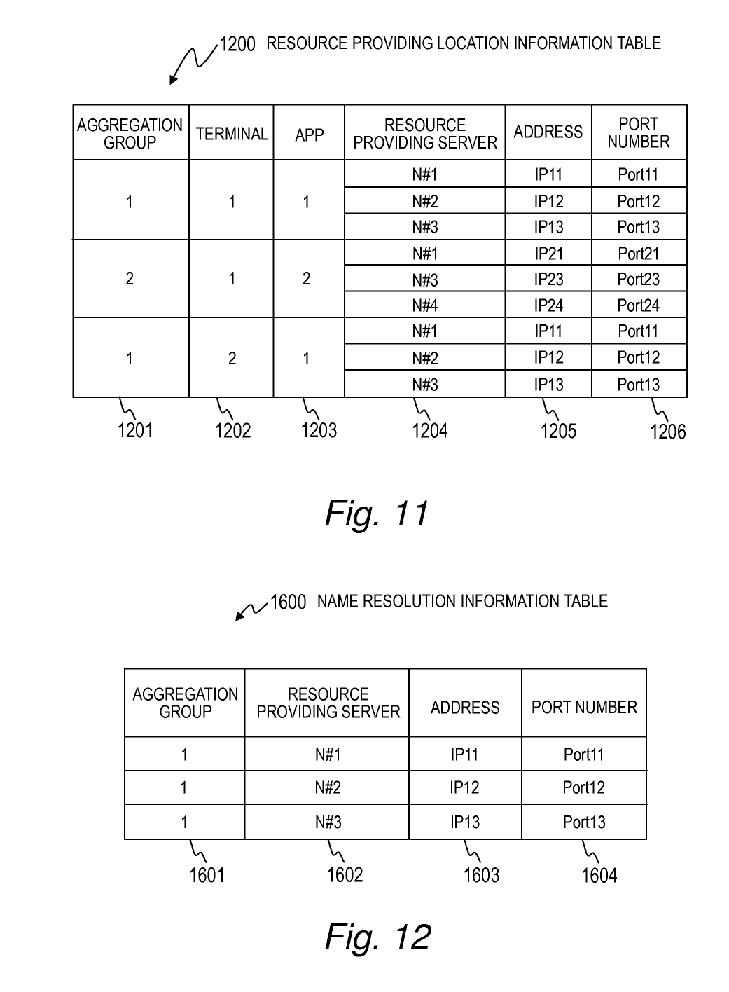

FIG. 11 is an explanatory diagram of the resource providing location information table 1200. The resource providing location information table 1200 is information that the network control server 100 receives from the resource management server 110, and indicates the location of the server 150 that provides software resources. Each record entry in the resource providing location information table 1200 includes an aggregation group 1201, a terminal 1202, an app 1203, a resource providing server 1204, an address 1205, and a port number 1206. An aggregation group identifier, a terminal identifier, and an application program identifier are stored as the aggregation group 1201, the terminal 1202, and the app 1203, respectively.

The resource providing server 1204 indicates, for each combination of one terminal 170 and an application program, the identifier of the server 150 that provides software resources to the terminal 170. The resource providing server 1204, the address 1205, and the port number 1206 may each have a plurality of values. In this case, the values of the resource providing server 1204, the values of the address 1205, and the values of the port number 1206 are managed in association with one another in a given order.

<Settings Information>

Described next are a name resolution information table 1600 and a settings information table 1950, which are created by the control module 211 from data that is managed by the data storage module 230.

FIG. 12 is an explanatory diagram of the name resolution information table 1600.

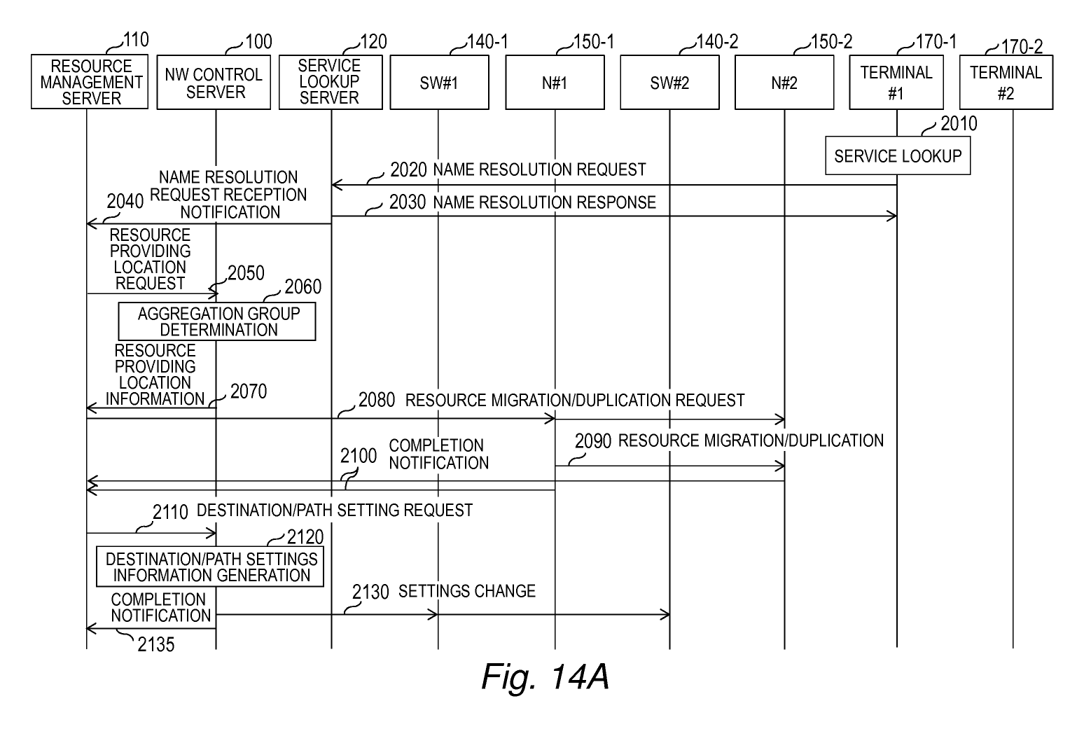

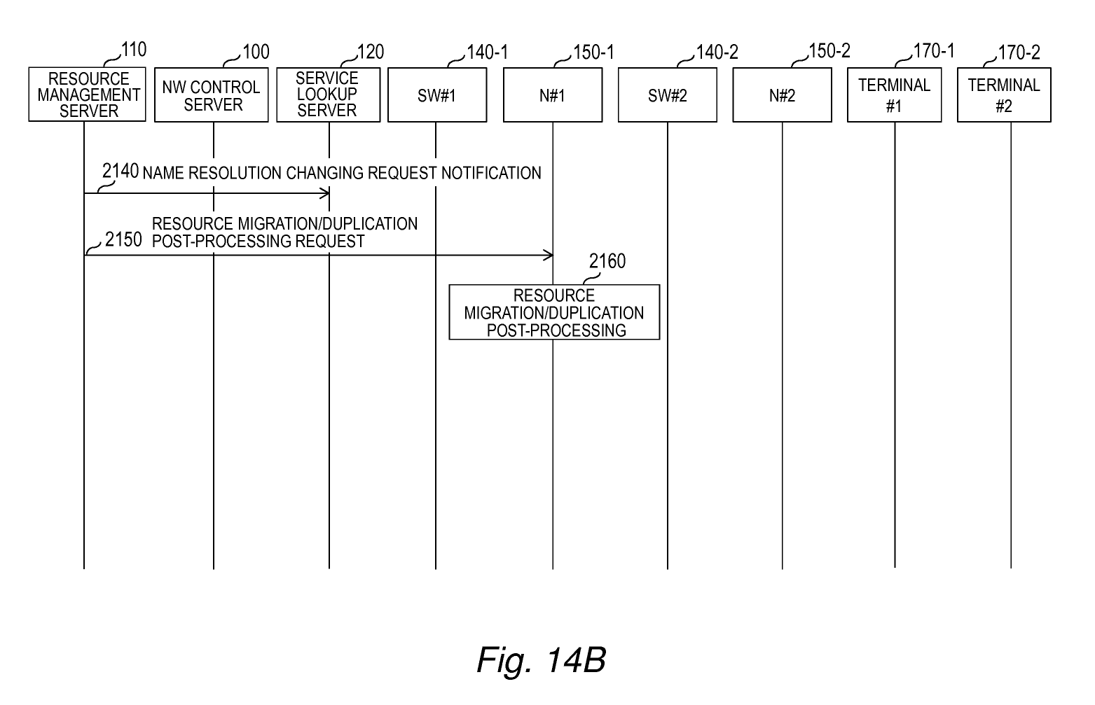

The name resolution information table 1600 is included in a completion notification that is transmitted by the network control server 100 to the resource management server 110 in Sequence Step 2135 of FIG. 14A described later. Each record entry in the name resolution information table 1600 includes an aggregation group 1601, a resource providing server 1602, an address 1603, and a port number 1604. An aggregation group identifier is stored as the aggregation group 1601. Stored as the resource providing server 1602 is the name or identifier of the server 150 that is associated with the aggregation group indicated by the aggregation group 1601. The IP address of this server 150 is stored as the address 1603. The port number 1604 indicates the port number of a port used by an application program. The name or identifier of the server 150 can be, for example, a URL or a domain name.

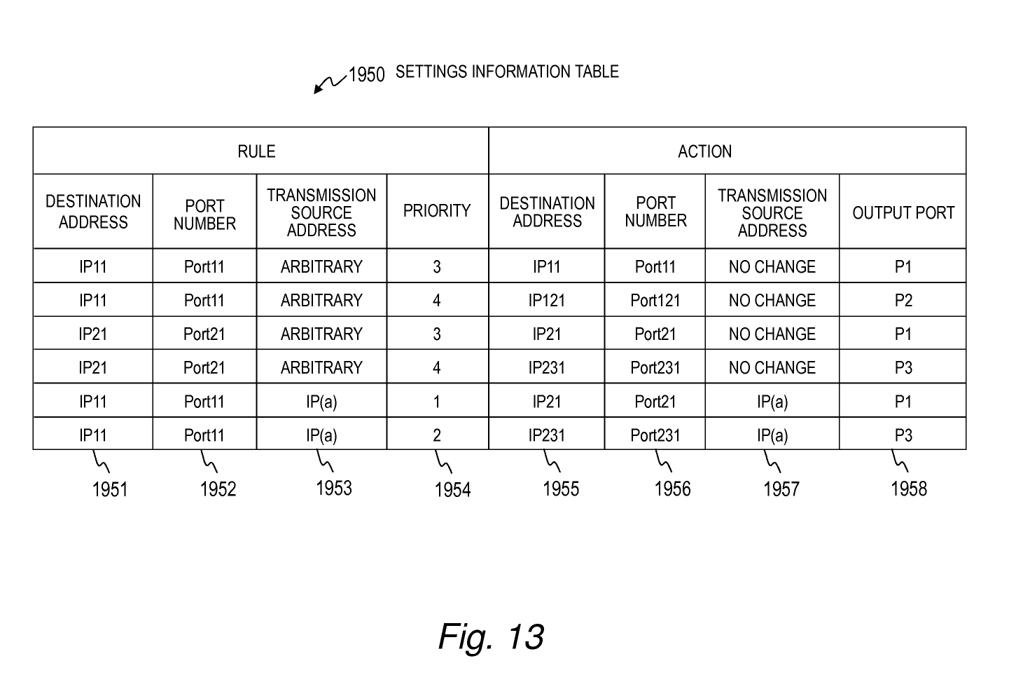

FIG. 13 is an explanatory diagram of the settings information table 1950. The settings information table 1950 is included in each of settings change messages that are created in Sequence Step 2130 of FIG. 14A described later by the network control server 100 for the communication apparatus 140-1 and the communication apparatus 140-2 separately, and that are transmitted in Sequence Step 2130 of FIG. 14A described later by the network control server 100 to the communication apparatus 140-1 and the communication apparatus 140-2.

Each record entry in the settings information table 1950 includes rules 1951 to 1954 and actions 1955 to 1958. The rules 1951 to 1954 indicate conditions for determining a processing method, which are used by the communication apparatus 140 that has received traffic. The rules 1951 to 1954 include a destination address 1951, a port number 1952, a transmission source address 1953, and a priority 1954. The destination address 1951 indicates a destination IP address that is contained in the header of the received traffic. The port number 1952 indicates a port number such as a TCP port number or a UDP port number that is contained in the header of the received traffic. The transmission source address 1953 indicates a transmission source IP address that is contained in the header of the received traffic. The priority 1954 indicates a value for determining which rule is associated with processing (an action) that is to be given priority when the received traffic fits a plurality of rules. However, when normal communication is not possible due to congestion, a failure, or maintenance, the communication apparatus 140 employs processing (an action) that is associated with a rule having the highest priority out of all the rules except one where normal communication is not possible.

A destination address 1955 indicates a destination IP address that is attached to the header of the traffic to be transferred. A port number 1956 indicates a port number such as a TCP port number or a UDP port number that is attached to the header of the traffic to be transferred. A transmission source address 1957 indicates a transmission source IP address that is attached to the header of the traffic to be transferred. An output port 1958 indicates a number for identifying the location of a port from which the communication apparatus 140 outputs the traffic.

<Description of a Sequence>

FIG. 14A and FIG. 14B are sequence diagrams for illustrating processing that is executed in this embodiment to determine an aggregation group and to set destination settings and path switching settings.

In Sequence Step 2010, the terminal 170-1 executes service lookup. Service lookup involves making an inquiry by the terminal 170 that needs to couple to one of the servers 150, namely, the servers 150-1 and 150-2, in order to view or update information on the screen of the terminal 170, about the IP address of the server 150 to which the terminal 170 is to be coupled. Service lookup is activated when a user of the terminal 170 boots or reboots an application program, or is activated periodically by a timer function that is provided in the terminal 170.

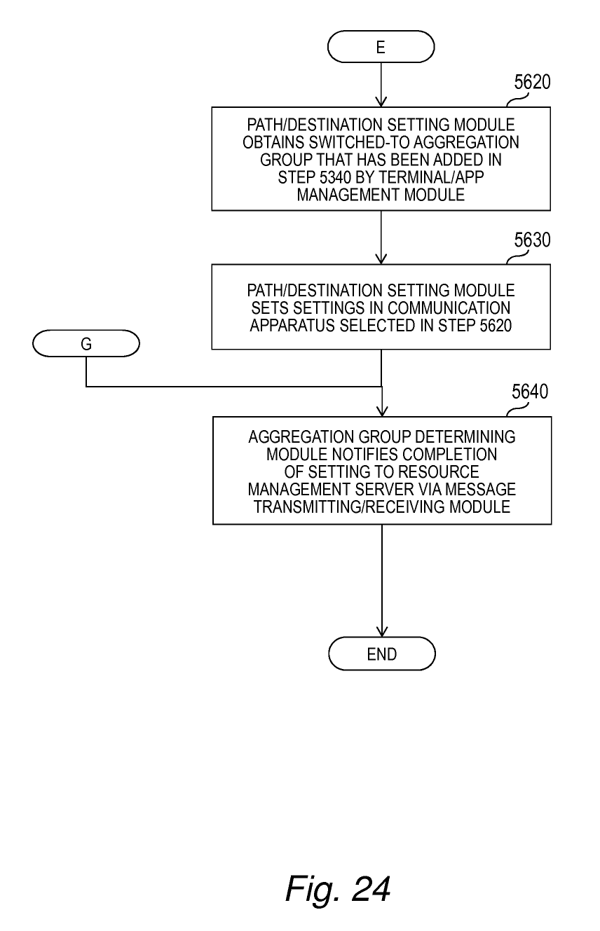

Activating service lookup periodically enables the network control server 100 to delete terminal/app-based settings information in Step 5630 of FIG. 24 after a fixed period of time (a length of time longer than a period in which the terminal 170 executes service lookup).

In Sequence Step 2020, the terminal 170-1 transmits a name resolution request to the service lookup server 120. The name resolution request includes the domain name of a server that provides software resources. This domain name is the identifier of the server 150 that is determined uniquely for each combination of an application program and the terminals 170 that are related to one another as a server that provides software resources to the terminal 170.

In Sequence Step 2030, the service lookup server 120 transmits a name resolution response to the terminal 170-1. The name resolution response includes an IP address that is associated with the received domain name, and a port number. In the case where the service lookup server 120 does not hold an IP address that is associated with the domain name related to a combination of an application program and the terminal 170 that has made the inquiry, and a port number, the IP address included in the response from the service lookup server 120 is the IP address of the default server 150.

In Sequence Step 2040, the service lookup server 120 transmits a name resolution request reception notification to the resource management server 110. The name resolution request reception notification includes the IP address and port number of the source from which the name resolution request has been transmitted in Sequence Step 2020, and the server IP address and port number notified in Sequence Step 2030. Sequence Step 2040 can be omitted in the case where the message of Sequence Step 2020 and the message of Sequence Step 2030 are both the same as messages transmitted/received in the past.

In Sequence Step 2050, the resource management server 110 issues a resource providing location request 2050 to the network control server 100. The resource providing location request includes the demanded communication characteristics information table 1100 of FIG. 10.

In Sequence Step 2060, the network control server 100 executes resource providing location determination. In the resource providing location determination, the network control server 100 calculates the resource providing location information table 1200 by referring to the demanded communication characteristics information table 1100, the inter-communication apparatus communication characteristics information table 1700, the access point-communication apparatus communication characteristics information table 1800, and the aggregation group information table 1300, and updates the aggregation group information table 1300.

<Processing of Aggregation Group Determination 2060>

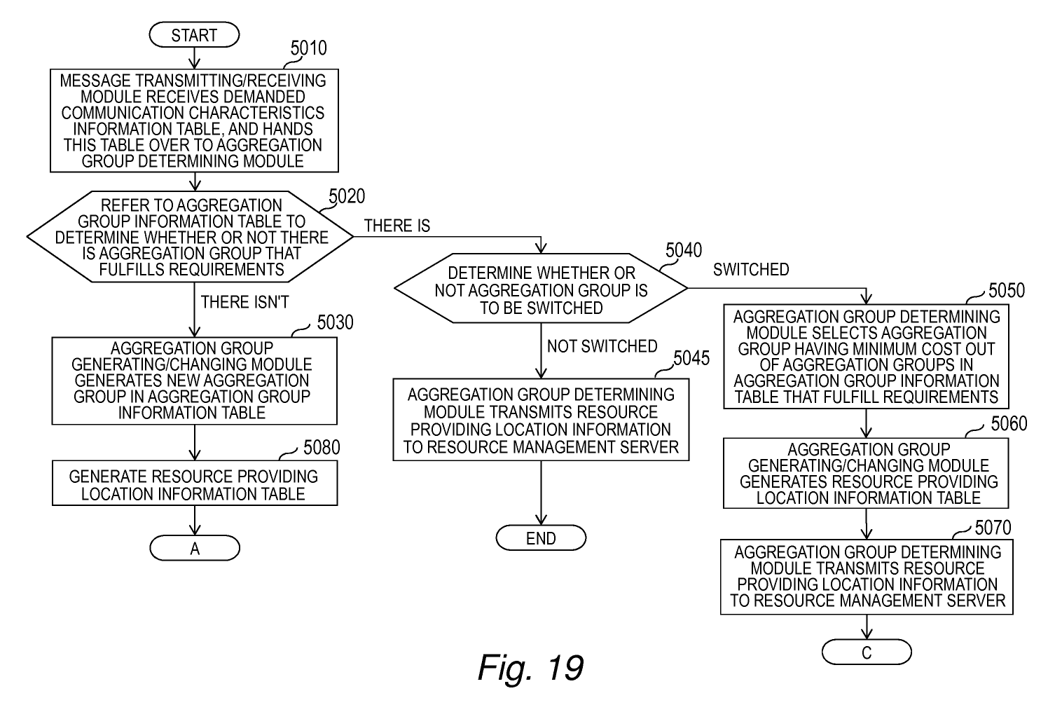

Processing executed in Sequence Step 2060 of FIG. 14A is described below with reference to FIG. 19. FIG. 19 is a flow chart for illustrating an example of processing in which the aggregation group determining module 201 and the aggregation group generating/changing module 204 determine an aggregation group.

In FIG. 19, the message transmitting/receiving module 210 of the network control server 100 first receives the demanded communication characteristics information table 1100 in Step 5010 and hands over the received table to the aggregation group determining module 201.

In Step 5020, the aggregation group determining module 201 receives the demanded communication characteristics information table 1100 from the message transmitting/receiving module 210, and refers to the aggregation group information table 1300 of FIG. 4 to determine whether or not there is an aggregation group that fulfills requirements.

The aggregation group determining module 201 obtains from the demanded communication characteristics information table 1100 the terminal 1101 and the app 1104, which are terminal/app basic information, the switching feasibility flag 1106, the (terminal-server) communication delay 1107 and the (inter-server) communication delay 1108, which are demanded delays, the (inter-server) bandwidth 1111, the stored data amount 1112, and the access point 1113.

The aggregation group determining module 201 searches the aggregation group information table 1300 of FIG. 4 for a row where the communication delay 1303, which is communication characteristics information, is smaller than the (inter-server) communication delay 1108 obtained in Step 5020, and the bandwidth 1304, which is communication characteristics information, is greater than the (inter-server) bandwidth 1111 obtained in Step 5020. The aggregation group determining module 201 selects the aggregation group 1301 and the resource providing server 1302 from the found row.

The aggregation group determining module 201 searches the access point-communication apparatus communication characteristics information table 1800 of FIG. 9 for a row where the access point 1801 and the communication apparatus 1802 match the access point 1113 of the demanded communication characteristics information table 1100 that is obtained in Step 5020, and obtains the communication delay 1803 and the bandwidth 1804 from the found row. The aggregation group determining module 201 further searches the table 1800 for a row where the communication delay 1803 is smaller than the (terminal-server) communication delay 1107 obtained in Step 5020, and the bandwidth 1804 is greater than the (terminal-server) bandwidth 1111 obtained in Step 5020, and obtains the access point 1801, the communication apparatus 1802, the communication delay 1803, and the bandwidth 1804 from the found row. The obtained access point 1801, communication apparatus 1802, communication delay 1803, and bandwidth 1804 are candidates that are referred to as access point candidate, communication apparatus candidate, communication delay candidate, and bandwidth candidate, respectively, in the following description.

The aggregation group determining module 201 searches the aggregation group information table 1300 of FIG. 4 for a row where the resource providing server 1302 is included among communication apparatus candidates, and obtains the aggregation group 1301 and the cost 1307 from the found row. The obtained aggregation group 1301 and cost 1307 are referred to as aggregation group candidate and cost candidate, respectively, in the following description.

The processing proceeds to Step 5040 when there are one or more aggregation group candidates, and to Step 5030 when there are no aggregation group candidates.

In Step 5030, the aggregation group generating/changing module 204 adds a new aggregation group to the aggregation group information table 1300. The added aggregation group is referred to as new aggregation group in the following description.

The aggregation group generating/changing module 204 adds a communication apparatus candidate as the resource providing server 1302 to a row of the aggregation group information table 1300 for the new aggregation group. When there are a large number of communication apparatus candidates, the aggregation group generating/changing module 204 selects a combination of communication apparatus candidates that makes the sum of communication delay candidates equal to or less than a given threshold, or that makes the sum of bandwidth candidates greater than a given threshold, and obtains servers adjacent to those communication apparatus 140. The selected communication apparatus candidates and the obtained servers 150 are referred to as new communication apparatus and new resource providing servers, respectively, in the following description.

In this manner, the number of servers registered as the resource providing server 1302 to an aggregation group is reduced, and the number of IP addresses required and the number of port numbers required, which are determined by the number of combinations of resource providing servers within an aggregation group, can be kept from swelling.

When the switching feasibility flag 1106 obtained in Step 5020 is “No” and there are a plurality of communication apparatus candidates, a communication apparatus that has the smallest communication delay candidate is selected as the communication apparatus candidate, and a server that is associated with the communication apparatus candidate is selected as the new resource providing server.

In this manner, a combination of one terminal 170 and an application program for which the relevant communication apparatus 140 autonomously changes the destination when a failure or congestion occurs, or when the switching of access points to which the terminal 170 is coupled necessitates a destination change, without receiving a notification from the resource management server 110, can coexist with a combination of one terminal 170 and an application program for which the relevant communication apparatus 140 does not change the destination autonomously.

The aggregation group generating/changing module 204 searches the inter-communication apparatus communication characteristics information table 1700 of FIG. 8 for a row where Communication Apparatus One (1701) and Communication Apparatus Two (1702) are new communication apparatus, and obtains the communication delay 1703 and the bandwidth 1704 from the found row. The aggregation group generating/changing module 204 obtains the maximum value of the obtained communication delay 1703 as a maximum communication delay, and the minimum value of the obtained bandwidth 1704 as a minimum bandwidth.

In the row for the new aggregation group, the aggregation group generating/changing module 204 adds the new resource providing server as the resource providing server 1302, the maximum communication delay as the communication delay 1303, the minimum bandwidth as the bandwidth 1304, the terminal 170 obtained in Step 5010 as the terminal 1305, and the app obtained in Step 5020 as the app 1306.

After Step 5030 is executed, the processing proceeds to Step 5080.

In Step 5040, the aggregation group determining module 201 determines whether or not to switch the aggregation groups.

The aggregation group determining module 201 determines whether or not the aggregation group information table 1300 includes a row where the terminal 1305 and the app 1306 match the terminal 1101 and app 1104 of the demanded communication characteristics information table 1100 that have been obtained in Step 5020. When the table 1300 includes the row, the aggregation group 1301 is obtained from the row. The obtained aggregation group is referred to as existing aggregation group in the following description.

The aggregation group determining module 201 compares the communication delay 1303, the bandwidth 1304, and the cost 1307 that are in the same row as the existing aggregation group with the communication delay candidate, bandwidth candidate, and cost candidate obtained in Step 5020. The aggregation group determining module 201 determines that the aggregation group is to be switched when the communication delay 1303 in the same row as the existing aggregation group is larger than the communication delay candidate, or when the bandwidth 1304 in the same row as the existing aggregation group is less than the bandwidth candidate, or when the cost 1307 in the same row as the existing aggregation group is larger than the cost candidate.

Alternatively, the aggregation group determining module 201 may search the aggregation group switching cost information table 1400 of FIG. 5 for a row where the terminal 1401 and the app 1402 match the terminal 1101 and the app 1104 of the demanded communication characteristics information table 1100 to obtain the switching cost 1403 from the found row, and to determine that the aggregation group is to be changed when the cost 1307 in the same row as the existing aggregation group is larger than the sum of the cost candidate and the obtained switching cost 1403.

The aggregation group determining module 201 can thus determine whether or not the switching of aggregation groups is necessary by taking into account a load that is incurred by the switching of aggregation groups. This prevents short-cycle fluctuations in communication delay and bandwidth between the communication apparatus 140 from causing frequent switching of an aggregation group that is optimum for a combination of one terminal 170 and an application program.

As a result, a traffic flow generated by switching the server 150 that provides software resources, which follows the switching of aggregation groups, is prevented from consuming the bandwidth of the network 130 and from encroaching on a bandwidth for communication between the terminals 170 and the servers 150, or communication between one server 150 and another server 150. In addition, when software resources are migrated from one server 150 to another server 150, the deletion/addition of software resources from/to the servers 150 is prevented from causing strain on CPUs, memories, and other resources of the servers 150.

The processing proceeds to Step 5050 when it is determined that the aggregation group is to be switched, and to Step 5045 when it is determined that the aggregation group is not to be switched.

In Step 5045, the aggregation group determining module 201 notifies the resource management server 110 via the message transmitting/receiving module 210 that the resource providing location is not to be changed. For example, the aggregation group determining module 201 transmits the resource providing location information table 1200 that is empty to the resource management server 110 via the message transmitting/receiving module 210.

In Step 5050, the aggregation group determining module 201 obtains, as a switched-to aggregation group, a candidate aggregation group for which it has been determined in Step 5040 that the communication delay 1303 in the same row as the existing aggregation group is larger than the communication delay candidate, that the bandwidth 1304 in the same row as the existing aggregation group is less than the bandwidth candidate, or that the cost 1307 in the same row as the existing aggregation group is larger than the cost candidate.

In Step 5060, the aggregation group generating/changing module 204 adds the switched-to aggregation group and the terminal 1101 and the app 1104 that have been obtained in Step 5020 to a new row in the resource providing location information table 1200 of FIG. 11 as the aggregation group 1201, the terminal 1202, and the app 1203, and adds, as the resource providing server 1204 in the same row, a resource providing server that is extracted from a row of the aggregation group information table 1300 where the aggregation group 1301 is the switched-to aggregation group. The aggregation group generating/changing module 204 then adds, as the address 1205 and the port number 1206 in the same row of the resource providing location information table 1200, an IP address and a port number that are an unused combination of an address and a port number.

In Step 5070, the aggregation group determining module 201 transmits the resource providing location information table 1200 to which information has been added in Step 5060 to the resource management server 110 via the message transmitting/receiving module 210.

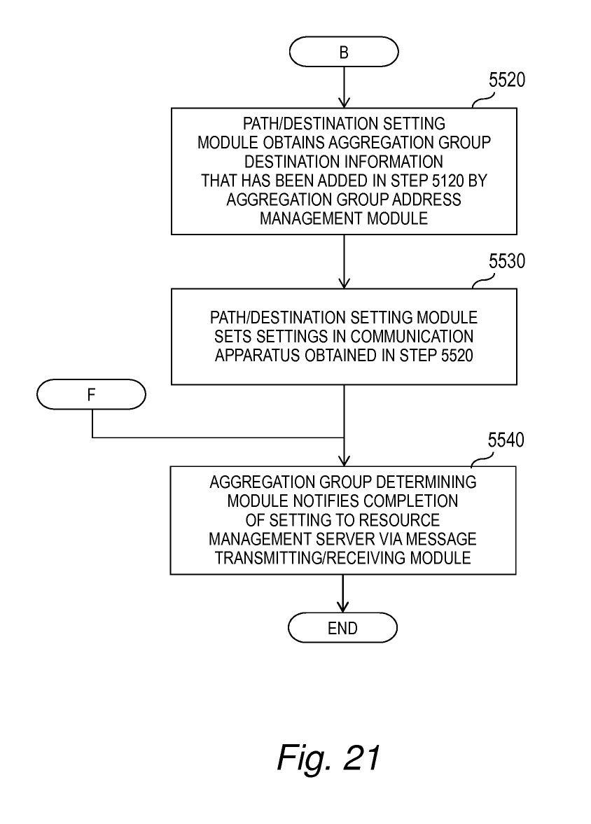

After Step 5070 is executed, the network control server 100 enters a standby state and, when receiving a destination/path setting request in Sequence Step 2110 of FIG. 14A, proceeds to C in FIG. 21.

In Step 5080, the aggregation group generating/changing module 204 creates the resource providing location information table 1200. The aggregation group generating/changing module 204 adds the new aggregation group and the terminal 1101 and the app 1104 that have been obtained in Step 5020 to a new row in the resource providing location information table 1200 as the aggregation group 1201, the terminal 1202, and the app 1203, adds the new resource providing server as the resource providing server 1204 in the same row of the table 1200, and adds an unused address and an unused port number as the address 1205 and the port number 1206 in the same row of the table 1200.

The aggregation group determining module 201 transmits the resource providing location information table 1200 to which information has been added in Step 5080 to the resource management server 110 via the message transmitting/receiving module 210.

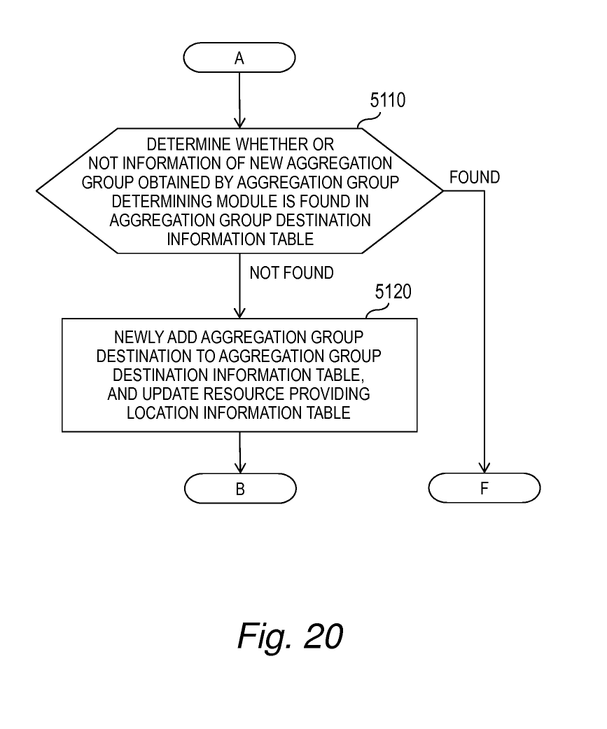

The network control server 100 enters a standby state and, when receiving a destination/path setting request in Sequence Step 2110 of FIG. 14A, proceeds to A in FIG. 20.

Through the processing described above, the network control server 100 assigns aggregation groups based on demanded communication characteristics, which are set for each combination of one terminal 170 and an application program, and the location of the terminal 170 in the network 130.

The network control server 100 next transmits resource providing location information to the resource management server 110 in Sequence Step 2070 of FIG. 14A. The resource providing location information includes the resource providing location information table 1200 of FIG. 11.

In Sequence Step 2080, the resource management server 110 transmits a resource migration/duplication request 2080 to servers specified as the resource providing server 1204 in the resource providing location information table 1200 (namely, the servers 150-1 and 150-2).

In Sequence Step 2090, based on a message received via the resource migration/duplication request, the server 150-1 migrates or copies, to the server 150-2, a software resource that is specified in the message. In the case where the software resource is copied, the server 150-1 and the server 150-2 are synchronized with each other so that a data update made by the terminal 170-1 to the resource of one of the servers is reflected on the other server.

In Sequence Step 2100, the server 150-1 and the server 150-2 notify the resource management server 110 of the completion of software resource migration or duplication.

In Sequence Step 2110, the resource management server 110 transmits a destination/path setting request to the network control server 100. The destination/path setting request includes the demanded communication characteristics information table 1100. In this sequence, in the case where the network control server 100 has already held the demanded communication characteristics information table 1100 received in Sequence Step 2120, the terminal/app basic information 1101 to the terminal/app basic information 1105 may be transmitted instead of the demanded communication characteristics information table 1100.

In Sequence Step 2120, the network control server 100 generates destination/path settings information in order to set a communication path in the relevant communication apparatus 140.

<Destination/Path Settings Information Generation 2120>

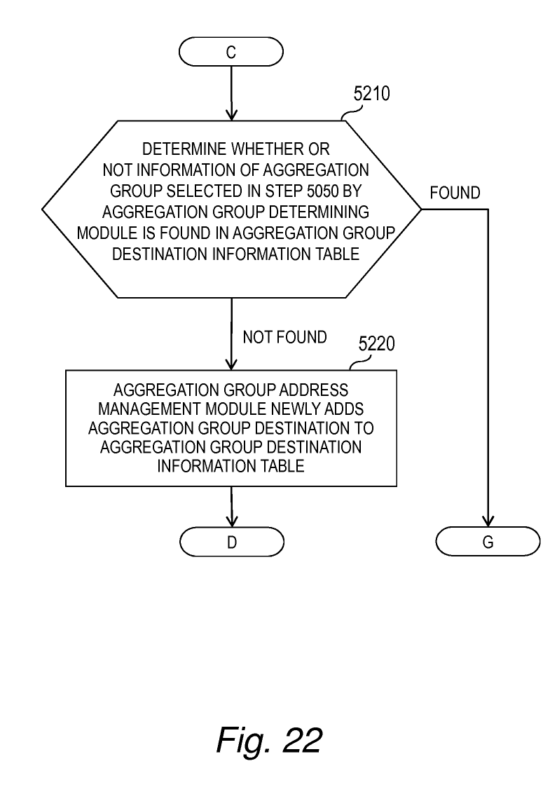

Processing that is executed in Sequence Step 2120 is described below with reference to FIG. 20 to FIG. 24. FIG. 20 and FIG. 21 are explanatory diagrams of processing that is executed to generate destination/path settings information when a software resource is newly added. FIG. 22 to FIG. 24 are explanatory diagrams of processing that is executed to generate destination/path settings information when a combination of one terminal 170 and an application program switches to a different aggregation group.

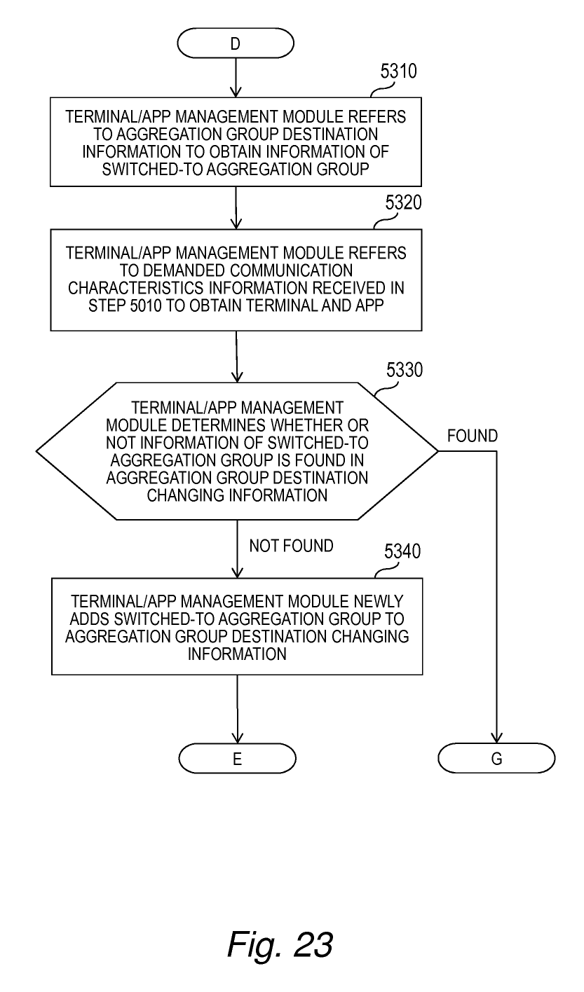

FIG. 20 is a flow chart for illustrating an example of processing in which the aggregation group address management module 202 generates settings information to be set in a communication apparatus when an aggregation group is added. FIG. 21 is a flow chart for illustrating an example of processing in which the path/destination setting module 209 sets a path and a destination in the relevant communication apparatus 140 when an aggregation group is added. FIG. 22 is a flow chart for illustrating an example of processing in which the aggregation group address management module 202 generates settings information to be set in the relevant communication apparatus 140 when a switch from one aggregation group to another is made. FIG. 23 is a flow chart for illustrating an example of processing in which the aggregation group address management module 202 generates settings information to be set in a communication apparatus, for each combination of an application program and interrelated terminals that is managed by the terminal/app management module 205, when a switch from one aggregation group to another is made. FIG. 24 is a flow chart for illustrating an example of processing in which the path/destination setting module 209 sets a path and a destination in a communication apparatus when a switch from one aggregation group to another is made.

In Step 5110 of FIG. 20, the aggregation group address management module 202 first determines whether or not the new aggregation group is stored as the aggregation group 1501 in the aggregation group destination information table 1500 of FIG. 6. The processing proceeds to F in FIG. 21 in the case where the new aggregation group is stored, and to Step 5120 in the case where the new aggregation group is not stored.

In Step 5120, the aggregation group address management module 202 adds information of the new aggregation group to the aggregation group destination information table 1500.

The aggregation group address management module 202 adds the new aggregation group as the aggregation group 1501 in a row of the aggregation group destination information table 1500, and adds the new communication apparatus as the setting target communication apparatus 1502 in the same row where the new aggregation group is added. When a plurality of communication apparatus qualify as new communication apparatus, the aggregation group address management module 202 adds all of the new communication apparatus as the transfer destination communication apparatus 1503 in a round robin fashion. The setting target communication apparatus 1502 and the transfer destination communication apparatus 1503 sharing the same value means that traffic of one communication apparatus 140 is not transferred to another communication apparatus 140.

In the same row of the aggregation group destination information table 1500 where the new aggregation group is added, the aggregation group address management module 202 adds, as the destination address 1504 and as the port number 1505, the address 1205 and the port number 1206 that are extracted from a row of the resource providing location information table 1200 where the aggregation group 1201 is the new aggregation group and the resource providing server 1204 is the setting target communication apparatus 1502 added in this step. The added address 1205 and port number 1206 are referred to as pre-transfer address and pre-transfer port number, respectively, in the following description.

In the same row of the aggregation group destination information table 1500 where the new aggregation group is added, the aggregation group address management module 202 adds a value “arbitrary”, which means an arbitrary address, as the transmission source address 1506, and adds a value “3”, which means an intermediate priority level, as the priority 1507 in the case where the setting target communication apparatus 1502 and the transfer destination communication apparatus 1503 in the row have the same value, and a value “4”, which is a priority level lower than “3”, as the priority 1507 in the case where the setting target communication apparatus 1502 and the transfer destination communication apparatus 1503 in the row have different values.

In the same row of the aggregation group destination information table 1500 where the new aggregation group is added, the aggregation group address management module 202 adds, as the output destination address 1508 and as the output port number 1509, the destination address 1504 and port number 1505 of the same row in the case where the setting target communication apparatus 1502 and the transfer destination communication apparatus 1503 in the row have the same value. The aggregation group address management module 202 then adds a value “no change”, which means that the destination address of the received traffic is not to be changed, as the output source address 1510, and adds the port number of a port coupled to an adjacent resource providing server as the output port 1511 in this row of the aggregation group destination information table 1500.

In the case where the setting target communication apparatus 1502 and the transfer destination communication apparatus 1503 in the row of the aggregation group destination information table 1500 have different values, the aggregation group address management module 202 adds, as the output destination address 1508 and as the output port number 1509, an unused IP address and an unused port number that are selected out of combinations of the address and port number of the server 150 adjacent to the setting target communication apparatus 1502. The address and port number added here are referred to as transfer address and transfer port number in the following description.

The aggregation group address management module 202 searches the resource providing location information table 1200 of FIG. 11 for a row where the aggregation group 1201 is the new aggregation group and the resource providing server 1204 is the new resource providing server, and adds the transfer address and the transfer port number to the found row as the address 1205 and the port number 1206.

The aggregation group address management module 202 adds the new aggregation group as the aggregation group 1501 in a row of the aggregation group destination information table 1500 and, in the same row where the new aggregation group is added, adds the new communication apparatus as the setting target communication apparatus 1502 and as the transfer destination communication apparatus 1503, adds a transfer destination address and a transfer destination port number as the transmission source address 1506 and as the port number 1505, and adds the value “3” indicating an intermediate priority level as the priority 1507. As the output destination address 1508, the aggregation group address management module 202 adds the value “no change”, which means that the destination address of the received traffic is not to be changed. The aggregation group address management module 202 adds the pre-transfer address and the pre-transfer port number as the output source address 1510 and as the output port number 1509, respectively.

In this step, the network control server 100 adds, as the transfer destination communication apparatus 1503, in association with each new communication apparatus included in the new aggregation group, another new communication apparatus that is included in the same aggregation group (the new aggregation group). With this addition, the network control server 100 instructs the communication apparatus 140 in question to execute processing of transferring to the adjacent server 150 the priority of which is normally intermediate.

In the case where a communication failure or congestion between one communication apparatus 140 and its adjacent server 150, a failure within the adjacent server 150, or maintenance necessitates a switch to communication to/from another server 150, the transmission of the IP address of this server 150 as a destination IP address by the relevant terminal 170 allows the network control server 100 to give an instruction to execute low-priority processing of transmitting via another transfer destination communication apparatus to a switched destination that is a server belonging to the same aggregation group.

The instruction enables the communication apparatus 140 to autonomously switch the destination in the event of the failure or congestion described above, or during maintenance. Destination switching due to a failure can therefore be completed in short time. In addition, because the communication apparatus 140 does not need to request an instruction on the processing method from the network control server 100, the network control server 100 can avoid strain on a CPU, a memory, and other resources that is caused by requests for instruction made to the network control server 100 by a plurality of communication apparatus 140 on an aggregation group-by-aggregation group basis.

As the output address 1508 and as the output port number 1509, the destination address 1504 and the port number 1505 of the same row are added, and the value “no change”, which means that the destination address of the received traffic is not to be changed, is added as the output source address 1510. The port number of the communication apparatus 140 coupled to the adjacent server 150 is added as the output port 1511.

Through this step, processing of changing the transmission source address 1506 and the port number 1505 to the pre-transfer address and the pre-transfer port number can be set to the transfer destination communication apparatus 1503 that is in the same row as the setting target communication apparatus 1502 that is instructed to change the destination address 1504 and the port number 1505 to the transfer destination address and the transfer destination port number. Traffic in this case does not always need to pass through the setting target communication apparatus 1502. Accordingly, the number of communication apparatus 140 through which the traffic passes and the communication delay of the traffic are smaller and the bandwidth of the passed communication apparatus 140 is consumed less than in the case where the setting target communication apparatus 1502 for which the destination address 1504 and the port number 1505 have been changed changes the transmission source address 1506 and the port number 1505.

After Step 5220 is executed, the processing proceeds to B in FIG. 21.

FIG. 21 is a flow chart of processing in which a destination and a communication path are set in the relevant communication apparatus 140.

In Step 5520, the path/destination setting module 209 obtains the setting target communication apparatus 1502 from a row of the aggregation group destination information table 1500 to which information has been added in Step 5120 by the aggregation group address management module 202. The path/destination setting module 209 then extracts the rules 1504 to 1507 and the actions 1508 to 1511 from rows where the setting target communication apparatus 1502 matches the obtained setting target communication apparatus 1502, and adds the extracted rules and actions as the rules 1951 to 1954 and the actions 1955 to 1958 in the settings information table 1950, thereby generating the settings information table 1950 for each setting target communication apparatus 1502.

In Step 5530, the path/destination setting module 209 transmits, to each setting target communication apparatus obtained in Step 5520, via the communication IF 250, the settings information table 1950 that is associated with the communication apparatus 140.

In Step 5540, the aggregation group determining module 201 adds the new aggregation group as the aggregation group 1601 in a row of the name resolution information table 1600 of FIG. 12, and in the same row where the new aggregation group is added, adds, as the resource providing server 1602, as the address 1603, and as the port number 1604, the resource providing server 1204, the address 1205, and the port number 1206 that are obtained from a row of the resource providing location information table 1200 where the aggregation group 1201 is the new aggregation group.

The aggregation group determining module 201 transmits the name resolution information table 1600 to the resource management server 110 via the message transmitting/receiving module 210.

With the execution of Step 5540, the processing of setting a destination and a communication path in the relevant communication apparatus 140 is completed.

FIG. 22 is a flow chart of processing in which a destination and a communication path are calculated when a combination of one terminal 170 and an application program switches to another aggregation group.

Step 5210 and Step 5220 are a modification of Step 5110 and Step 5120 of FIG. 20 in which “new aggregation group” is replaced by “switched-to aggregation group”. Step 5210 is modified so that, when it is determined that the aggregation group selected in Step 5050 is found in the aggregation group destination information table 1500, the processing proceeds to G instead of F in the case of FIG. 20.

FIG. 23 is a flow chart of processing in which, when a combination of one terminal 170 and an application program switches to another aggregation group, a destination and a communication path are calculated in order to change the current destination based on the transmission source address.

In Step 5310, the terminal/app management module 205 refers to the aggregation group destination information table 1500 to obtain information of the switched-to aggregation group.

The terminal/app management module 205 obtains the management information 1501 to the management information 1503, the rules 1504 to 1507, and the actions 1508 to 1511 from a row of the aggregation group destination information table 1500 where the aggregation group 1501 is the switched-to aggregation group.

In Step 5320, the terminal/app management module 205 refers to the demanded communication characteristics information table 1100 received in Step 5010 to obtain the terminal 1101 and the app 1104.

In Step 5330, the terminal/app management module 205 determines whether or not information of the switched-to aggregation group is found in the aggregation group destination changing information table 1900.

The terminal/app management module 205 determines whether or not the aggregation group destination changing information table 1900 includes a row where the terminal 1901 and the app 1902 match the terminal 1101 and the app 1104 obtained in Step 5320, and the post-switch aggregation group 1904 is the switched-to aggregation group. The processing proceeds to G in FIG. 24 when a row where the post-switch aggregation group 1904 is the switched-to aggregation group is included in the table 1900, and to Step 5340 when no such row is included.

In Step 5340, the terminal/app management module 205 newly adds the switched-to aggregation group to the aggregation group destination changing information table 1900.

In the aggregation group destination changing information table 1900, the terminal/app management module 205 adds, as the terminal 1901 and as the app 1902, the terminal 1101 and the app 1104 obtained in Step 5320, adds, as the pre-switch aggregation group 1903, the existing aggregation group obtained in Step 5040 of FIG. 19, and adds, as the post-switch aggregation group 1904, the switched-to aggregation group obtained in Step 5050 of FIG. 19.

As the setting target communication apparatus 1905, the transfer destination communication apparatus 1906, the rules 1907 to 1910, and the actions 1911 to 1914 in the aggregation group destination changing information table 1900, the terminal/app management module 205 respectively adds the setting target communication apparatus 1502, the transfer destination communication apparatus 1503, the rules 1504 to 1507, and the actions 1508 to 1511 that are obtained from a row of the aggregation group destination information table 1500 where the aggregation group 1501 is the switched-to aggregation group. The terminal/app management module 205 then makes the following three changes:

In the case where the destination address 1504 has the value “arbitrary” in the aggregation group destination information table 1500, the terminal/app management module 205 changes the destination address 1907 in the aggregation group destination changing information table 1900 to the address of the terminal 1101 obtained in Step 5320.

In the case where the transmission source address 1506 has the value “arbitrary” in the aggregation group destination information table 1500, the terminal/app management module 205 changes the transmission source address 1909 in the aggregation group destination changing information table 1900 to the address of the terminal 1101 obtained in Step 5320.

The terminal/app management module 205 sets the priority 1910 in the aggregation group destination changing information table 1900 to a value “1”, which indicates the highest priority level, in the case where the priority 1507 in the aggregation group destination information table 1500 is the intermediate priority level 3, and sets the priority 1910 to a value “2”, which indicates a high priority level, in the case where the priority 1507 has a value that indicates low priority.

After Step 5340 is executed, the processing proceeds to E in FIG. 24.

FIG. 24 is a flow chart of processing in which a destination and a communication path are set in the relevant communication apparatus 140 when a combination of one terminal 170 and an application program switches to another aggregation group.

In Step 5620, the path/destination setting module 209 generates settings information for each setting target communication apparatus.

The path/destination setting module 209 obtains the setting target communication apparatus 1502 from a row of the aggregation group destination information table 1500 to which information has been added in Step 5220 by the aggregation group address management module 202. The path/destination setting module 209 then extracts the rules 1504 to 1507 and the actions 1508 to 1511 from rows where the setting target communication apparatus 1502 matches the obtained setting target communication apparatus 1502, and adds the extracted rules and actions as the rules 1951 to 1954 and the actions 1955 to 1958 in the settings information table 1950.

The path/destination setting module 209 also obtains the setting target communication apparatus 1905 from a row of the aggregation group destination changing information table 1900 to which information has been added in Step 5340 by the terminal/app management module 205. The path/destination setting module 209 then extracts the rules 1907 to 1910 and the actions 1911 to 1914 from rows where the setting target communication apparatus 1905 matches the obtained setting target communication apparatus 1905, and adds the extracted rules and actions as the rules 1951 to 1954 and the actions 1955 to 1958 in the settings information table 1950. The information added based on the aggregation group destination changing information table 1900 is referred to as terminal/app-based settings information in the following description.

In Step 5630, the path/destination setting module 209 transmits, to each setting target communication apparatus obtained in Step 5620, via the communication IF 250, the settings information table 1950 that is associated with the communication apparatus 140.

In Step 5640, the aggregation group determining module 201 adds the new aggregation group as the aggregation group 1601 in a row of the name resolution information table 1600, and in the same row where the new aggregation group is added, adds, as the resource providing server 1602, as the address 1603, and as the port number 1604, the resource providing server 1204, the address 1205, and the port number 1206 that are obtained from a row of the resource providing location information table 1200 where the aggregation group 1201 is the switched-to aggregation group.

The aggregation group determining module 201 transmits the name resolution information table 1600 to the resource management server 110 via the message transmitting/receiving module 210.

With the execution of Step 5640, the processing of setting a destination and a communication path in the relevant communication apparatus 140 is completed.

Through the processing of FIG. 22 to FIG. 24, when the terminal 170 that has switched to another aggregation group by switching the server 150 that provides software resources to the terminal 170 erroneously uses the address and port number of the server 150 that has previously provided software resources to the terminal 170 as the destination of transmission, the relevant communication apparatus 140 can autonomously change the destination so that the transmission is transferred to the server 150 that currently provides software resources to the terminal 170. This enables the terminal 170 to use software resources uninterruptedly in a period after software resources are migrated and even before the terminal 170 executes service lookup.

The network control server 100 may instruct the setting target communication apparatus to delete the terminal/app-based settings information set in Step 5630 after a fixed period of time, or when a notification is received from the resource management server 110. The fixed period of time is an arbitrary length of time that is longer than the length of service lookup executed by the terminal 170 in Sequence Step 2010 of FIG. 14A. This way, the terminal/app-based settings information, which can possibly grow to the largest size among pieces of information held in each communication apparatus 140, is reduced and a forwarding table held in the communication apparatus 140 is prevented from swelling up and adding to the processing load on the communication apparatus 104.

Returning to FIG. 14A, the network control server 100 transmits a setting change message in Sequence Step 2130 to the communication apparatus 140 that is registered as the setting target communication apparatus 1502 in the added row of the aggregation group destination information table 1500. The setting change message includes the settings information table 1950.

In Sequence Step 2135, the network control server 100 sends a destination/path setting completion notification to the resource management server 110. The destination/path setting completion notification includes the name resolution information table 1600.

In Sequence Step 2140 of FIG. 14B, the resource management server 110 sends a name resolution changing request notification to the service lookup server 120. The name resolution changing request notification includes the name resolution information table 1600.

In Sequence Step 2150, the resource management server 110 transmits a resource migration/duplication post-processing request to the server 150-1 to which a resource migration/duplication request has been transmitted in Step 2080. Resource migration/duplication post-processing includes deleting information (software resources) in the server 150-1 that is rendered unnecessary by the migration of software resources from the server 150-1 to the server 150-2. This step can be omitted in the case where the resource migration/duplication post-processing is not necessary.

In Sequence Step 2160, the server 150-1 executes the resource migration/duplication post-processing.

Through the processing described above, software resources are migrated from the server 150-1 to the server 150-2, and the server accessed by the aggregation group to which the terminal 170-1 belongs is switched to the server 150-2.

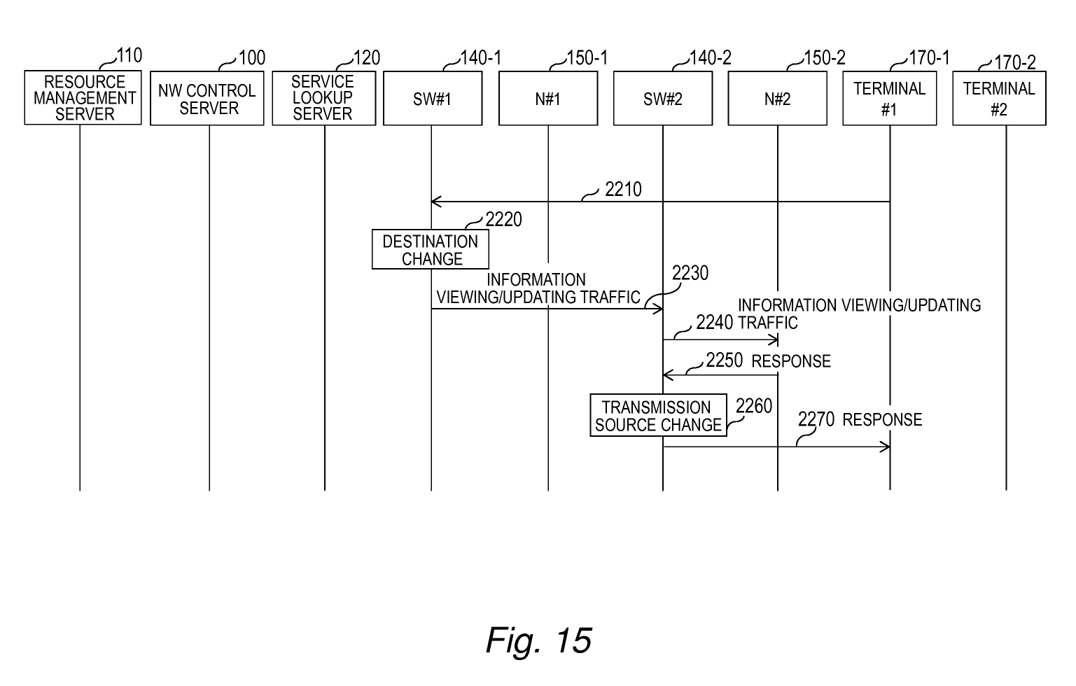

FIG. 15 to FIG. 18 are sequence diagrams of processing that is executed by each terminal 170 in this embodiment to view or update software resources.

FIG. 15 is a sequence diagram of processing in which the terminal 170 makes a request to view or update a software resource in a period that is immediately after the processing described with reference to the sequence diagrams of FIG. 14A and FIG. 14B is executed once, and that lasts until processing equivalent to Sequence Step 2010 to Sequence Step 2030 is executed again. This processing precedes the service lookup executed by the terminal 170-1.

In Sequence Step 2210 of FIG. 15, the terminal 170-1 transmits information viewing/updating traffic to the server 150-1. The destination IP address and port number of the information viewing/updating traffic is an IP address and a port number that are specified by a name resolution response that the terminal 170-1 has received from the service lookup server 120 last. The transmission source IP address of the information viewing/updating traffic is the IP address of the terminal 170-1 itself.

In Sequence Step 2220, the communication apparatus 140-1 receives the information viewing/updating traffic transmitted in Sequence Step 2210 from the terminal 170-1, and executes destination change. The communication apparatus 140-1 obtains the destination IP address, port number, and transmission source IP address of the received traffic, searches the settings information table 1950 for a row where the traffic fits the rules 1951 to 1954, and performs, on the received traffic, processing prescribed by the actions 1955 to 1958 of the found row.

In Sequence Step 2230, the communication apparatus 140-1 transmits the traffic to the server 150-2 in the case where the destination IP address and port number of the traffic processed in Sequence Step 2220 are those of the server 150-2.

In Sequence Step 2240, the communication apparatus 140-2 transfers the received information viewing/updating traffic to the server 150-2.

In Sequence Step 2250, the server 150-2 transmits to the communication apparatus 140-2 a response to the information viewing/updating traffic. The destination IP address, port number, and transmission source IP address of the response traffic transmitted are the transmission source IP address that is written in the header of the received traffic, the port number that is written in the header of the received traffic, and the destination IP address that is written in the header of the received traffic, respectively.

In Sequence Step 2260, the communication apparatus 140-2 receives the response traffic transmitted in Sequence Step 2250 from the server 150-2, and executes destination change. The communication apparatus 140-2 obtains the destination IP address, port number, and transmission source IP address of the received traffic, searches the settings information table 1950 for a row where the traffic fits the rules 1951 to 1954, and performs, on the received traffic, processing prescribed by the actions 1955 to 1958 of the found row.

In Sequence Step 2270, the communication apparatus 140-2 transfers the received information viewing/updating traffic to the terminal 170-1.

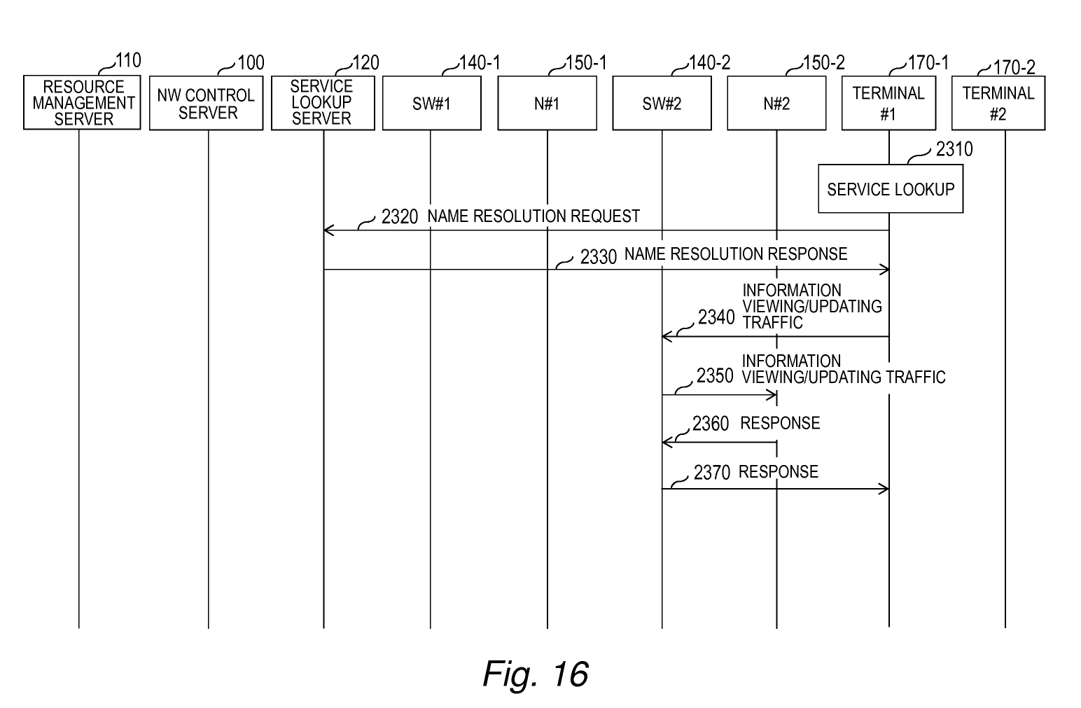

FIG. 16 is a sequence diagram of processing in which the terminal 170 makes a viewing request or an updating request to the server 150 that provides software resources to the terminal 170 when processing equivalent to Sequence Step 2010 to Sequence Step 2030 is executed again after the processing of the sequence diagrams of FIG. 14A and FIG. 14B is executed once. This processing is executed after the service lookup of the terminal 170-1.

In Sequence Step 2310, the terminal 170-1 executes service lookup. The service lookup is activated after a user of the terminal 170-1 boots or reboots an application program, or is activated periodically by a timer function that is provided in the terminal 170-1.

In Sequence Step 2320, the terminal 170-1 transmits a name resolution request to the service lookup server 120.

In Sequence Step 2330, the service lookup server 120 transmits a name resolution response to the terminal 170-1. The name resolution response includes an IP address that is associated with a received domain name, and a port number.

In Sequence Step 2340, the terminal 170-1 transmits information viewing/updating traffic that is destined to the server 150-2. The destination IP address and port number of the information viewing/updating traffic is an IP address and a port number that are specified by a name resolution response that the terminal 170-1 has received from the service lookup server 120 last. The transmission source IP address of the information viewing/updating traffic is the IP address of the terminal 170-1 itself.

In Sequence Step 2350, the communication apparatus 140-2 transfers the received information viewing/updating traffic to the server 150-2.

In Sequence Step 2360, the server 150-2 transmits to the communication apparatus 140-2 a response to the information viewing/updating traffic. The destination IP address, port number, and transmission source IP address of the response traffic transmitted are the transmission source IP address that is written in the header of the received traffic, the port number that is written in the header of the received traffic, and the destination IP address that is written in the header of the received traffic, respectively.

In Sequence Step 2360, the server 150-2 transfers the information viewing/updating traffic to the communication apparatus 140-2.

In Sequence Step 2370, the communication apparatus 140-2 transfers the received information viewing/updating traffic to the terminal 170-1.

<In Time of Failure>

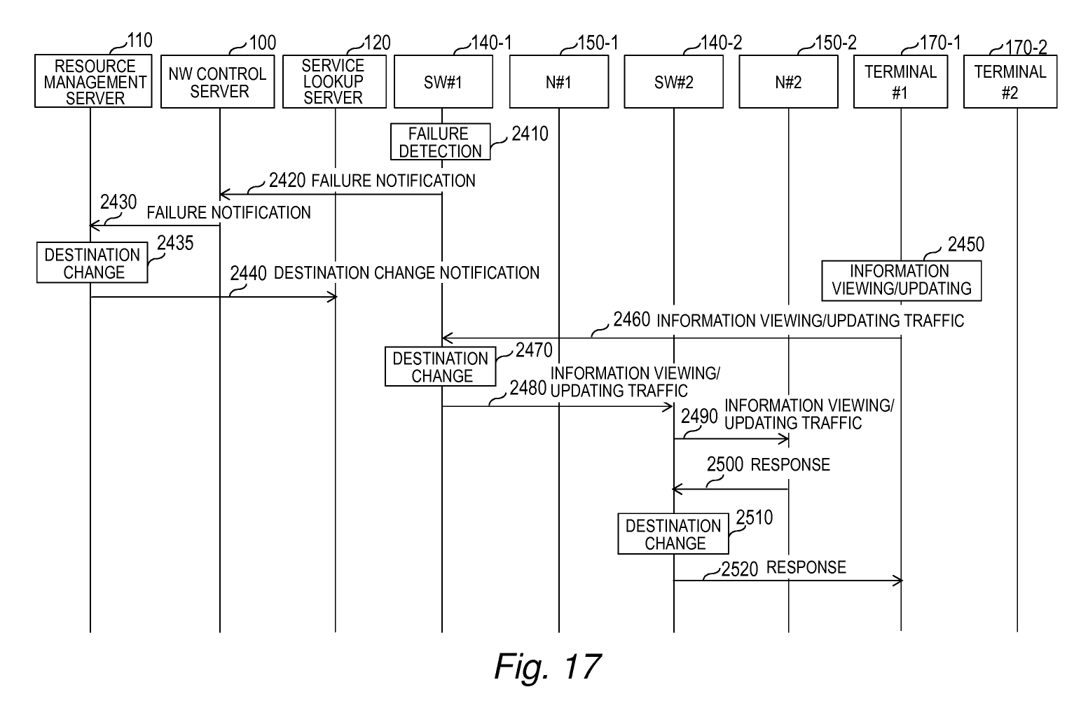

FIG. 17 is a sequence diagram of processing that is executed when a failure occurs between the communication apparatus 140-1 and the server 150-1, or within the server 150-1.

In Sequence Step 2410, the communication apparatus 140-1 detects a failure. Examples of the failure include link down, congestion, or other communication failures between the communication apparatus 140-1 and the server 150-1, a failure in the server 150-1 such as the shutdown of an application program of the server 150-1, and system shutdown for maintenance.

The communication failure is detected by the communication apparatus 140-1 as a failure in the server 150-1 from port down of the communication apparatus 140-1. To detect the failure in the server 150-1, the communication apparatus 140-1 identifies heartbeat traffic between the server 150-1 and the server 150-2 from the destination IP address, port number, and transmission source IP address of the traffic, and monitors the uplink packet quantity and downlink packet quantity of the traffic. The volume of heartbeat traffic from the server 150-1 decreases when a failure occurs in the server 150-1, and a reduction in heartbeat traffic volume is determined as a failure.

The resource management server 110 or the network control server 100 may execute failure detection, instead of the communication apparatus 140-1, and notify a detected failure to the communication apparatus 140-1.

In Sequence Step 2420, the communication apparatus 140-1 transmits the specifics of the failure that has occurred to the network control server 100.

In Sequence Step 2430, the network control server 100 transmits to the resource management server 110 the specifics of the failure received from the communication apparatus 140-1.

In Sequence Step 2435, the resource management server 110 recognizes that a failure has occurred in the server 150-1 from the failure specifics message received in Sequence Step 2430, and changes the IP address of the server 150-1 in the name resolution information table 1600 to the IP address of the server 150-2, which belongs to the same aggregation group as the server 150-1.

In Sequence Step 2440, the resource management server 110 transmits a name resolution change notification to the service lookup server 120. The name resolution change notification includes the name resolution information table 1600 that has been updated in Sequence Step 2435.

Processing from information viewing or updating in Sequence Step 2450 to response in Sequence Step 2520 is the same as the processing from Sequence Step 2210 to Sequence Step 2270 in FIG. 15.

Processing in which the terminal 170 makes a viewing request or an updating request to the server 150 that provides software resources to the terminal 170 when processing equivalent to Sequence Step 2010 to Sequence Step 2030 of FIG. 14A is executed again after the processing from Sequence Step 2410 to Sequence Step 2440 is executed once is the same as Sequence Step 2310 to Sequence Step 2370 of FIG. 16.

<In Time of Terminal Travel>

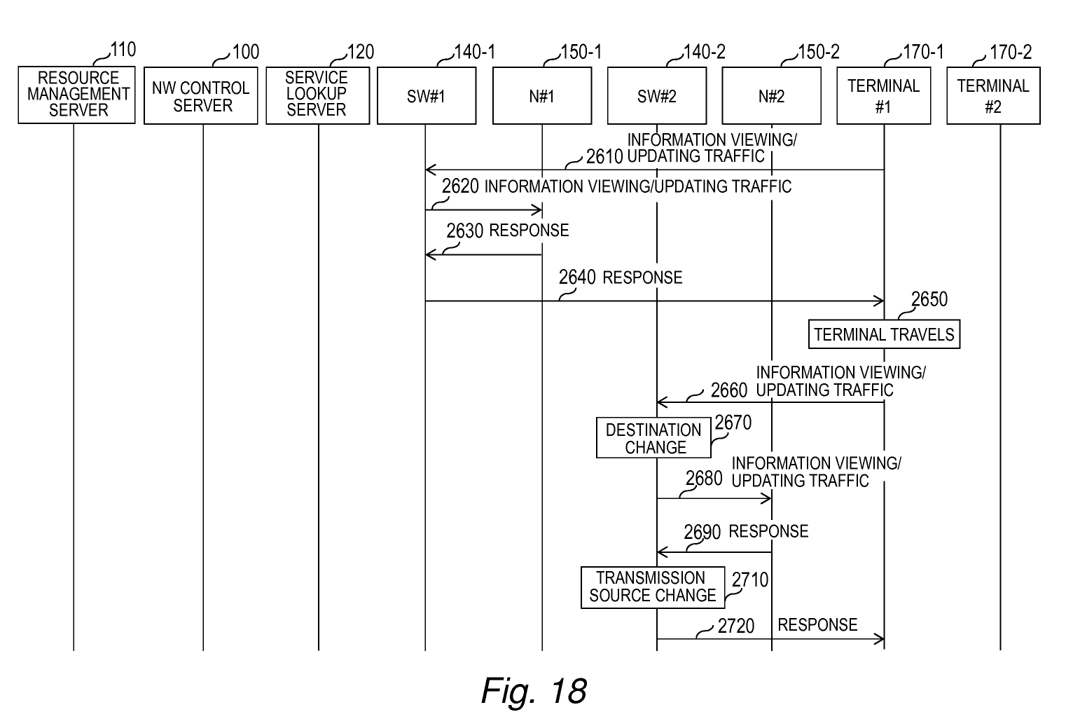

FIG. 18 is an explanatory diagram of processing in which, after traveling of the terminal 170 that has been using the server 150-1 to view or update information renders the server 150-2 a server nearest to the terminal 170, instead of the server 150-1, and before processing equivalent to Sequence Step 2010 to Sequence Step 2030 of FIG. 14A is executed again, the terminal 170 makes a request to view or update a software resource.

In Sequence Step 2610, the terminal 170-1 transmits information viewing/updating traffic destined to the server 150-1. The destination IP address and port number of the information viewing/updating traffic are an IP address and a port number that are specified by a name resolution response that the terminal 170-1 has received from the service lookup server 120 last. The transmission source IP address of the information viewing/updating traffic is the IP address of the terminal 170-1 itself.

In Sequence Step 2620, the communication apparatus 140-1 transfers the received information viewing/updating traffic to the server 150-1.

In Sequence Step 2630, the server 150-1 transmits to the communication apparatus 140-1 a response to the information viewing/updating traffic. The destination IP address, port number, and transmission source IP address of the response traffic transmitted are the transmission source IP address that is written in the header of the received traffic, the port number that is written in the header of the received traffic, and the destination IP address that is written in the header of the received traffic, respectively.

In Sequence Step 2640, the communication apparatus 140-1 transmits, to the terminal 170-1, traffic that is a response to the information viewing/updating traffic.

In Sequence Step 2650, the traveling of the terminal 170-1 causes switching of the access point 160 to which the terminal 170-1 is coupled to the access point 160-2, which is situated so that the RTT to the server 150-2 is smaller than the RTT to the server 150-1.

In Sequence Step 2660, the terminal 170-1 transmits information viewing/updating traffic destined to the server 150-1. The destination IP address and port number of this information viewing/updating traffic are the same as the destination IP address and port number of the information viewing/updating traffic that has been transmitted from the terminal 170-1 in Sequence Step 2610.

In Sequence Step 2670, the communication apparatus 140-2 receives the information viewing/updating traffic transmitted in Sequence Step 2660 from the terminal 170-1, and executes destination change.

The communication apparatus 140-2 obtains the destination IP address, port number, and transmission source IP address of the received traffic, searches the settings information table 1950 for a row where the traffic fits the rules of the table 1950, and performs, on the received traffic, processing prescribed by actions that are written in the found row. The settings information table 1950 is generated for each communication apparatus 140 in advance by the network control server 100. Rules and actions in the settings information table 1950 are set so that, when the port number 1952 is the same, the destination is changed to the destination address 1955 that is smaller in communication delay. For example, when application programs provided by the servers 150 that are coupled to the communication apparatus 140 in question are associated with the same port number 1952, the destination server 150 of traffic of the traveling terminal 170 is switched to the server 150 that is under control of the communication apparatus 140 in question. The server 150 that is small in communication delay can thus be provided to the terminal 170.

In Sequence Step 2680, the communication apparatus 140-2 transmits the traffic to the server 150-2 in the case where the destination IP address and port number of the traffic processed in Sequence Step 2670 are those of the server 150-2.

In Sequence Step 2680, the communication apparatus 140-2 transfers the received information viewing/updating traffic to the server 150-2.

In Sequence Step 2690, the server 150-2 transmits to the communication apparatus 140-2 a response to the information viewing/updating traffic. The destination IP address, port number, and transmission source IP address of the response traffic transmitted are the transmission source IP address that is written in the header of the received traffic, the port number that is written in the header of the received traffic, and the destination IP address that is written in the header of the received traffic, respectively.

In Sequence Step 2710, the communication apparatus 140-2 receives the response traffic transmitted in Sequence Step 2690 from the server 150-2, and executes destination change. The communication apparatus 140-2 obtains the destination IP address, port number, and transmission source IP address of the received traffic, searches the settings information table 1950 for a row where the traffic fits the rules of the table 1950, and performs, on the received traffic, processing prescribed by the actions that are written in the found row.

In Sequence Step 2720, the communication apparatus 140-2 transfers the received information viewing/updating traffic to the terminal 170-1.

In the manner described above, when traveling of the terminal 170-1 causes switching of the access points 160, the terminal 170-1 is automatically switched to the server 150 that is selected as a small-delay server out of the servers 150 that provide software resources.

While the embodiment described above is an example of running the network control server 100, the resource management server 110, and the service lookup server 120 on different computers, the functions of the respective servers may be provided by a single computer. In this case, the single computer provides a network control module, a resource providing module, and a service lookup module.

As described above, this invention allows each terminal 170 to couple to the server 150 that is optimum for a combination of the terminal 170 and an application program in an environment where a plurality of servers 150 for providing software resources are dispersed throughout the network 130, even when the server that provides software resources to the terminal 170 is switched from one server 150 to another, or when the terminal 170 travels, or in other similar cases, while preventing the processing load on the network control server 100 and the processing load on the communication apparatus 140 from increasing with an increase in the number of terminals 170 or an increase in traffic volume.

A first feature of this invention involves, as described above, in a computer system that includes the communication apparatus 140 for changing the destination address or transmission source address of traffic, and the servers 150 for providing software resources for each combination of an application program and the terminals 170, managing as a logical aggregation group a combination of the terminals 170 that have the same server 150 as a software resource providing server and an application program run on the terminals 170, and notifying settings information to the communication apparatus 140 and the resource server management 100 on an aggregation group-by-aggregation group basis.

The network control server 100 can thus change settings by notifying settings to the communication apparatus 140 and the resource management server 110 for each aggregation group, which is a combination of an application program and the terminals 170 that are related to one another. In short, CPU burden and memory usage of the network control server 100 are smaller than in the related art described above, where settings information is notified for each of the IP addresses of the terminals 170.

A second feature of this invention involves, in a computer system that includes the communication apparatus 140 for changing the destination address or transmission source address of traffic, the servers 150 for providing software resources for each combination of an application program and the terminals 170, the resource management server 110 for managing the servers 150, and the service lookup server 120 for executing name resolution for each combination of an application program and the terminals 170, setting each communication apparatus 140 by associating an aggregation group with the IP address and port number of the server 150 that provides software resources.

The communication apparatus 140 can thus transfer traffic to the server 150 that provide software resources to the terminal 170 in question based on the combination of the terminal 170 and an application program, by referring to the IP address and the port number instead of Layer 7 information such as a cookie, even when a different combination of an application program and the terminals 170 is provided with software resources by a different destination server 150.

A third feature of this invention involves, in the second feature, associating an aggregation group with the IP addresses and port numbers of a plurality of servers 150 that provide software resources. Each communication apparatus 140 is set so that the IP addresses and port numbers of one server 150 and another server 150 that are associated with the same aggregation group can be interchanged.

This enables the communication apparatus 140 to autonomously change the destination to another server 150 that belongs to the same aggregation group, based on the settings set in the communication apparatus 140, when a given trigger event such as failure or congestion occurs. The communication apparatus 140 can thus switch paths in a short length of time.

A fourth feature of this invention involves, in the second feature, associating an aggregation group with the IP addresses and port numbers of a plurality of servers 150 that provide software resources. The IP addresses and port numbers of one server 150 and another server 150 that are associated with the same aggregation group are associated with each other, and each communication apparatus 140 is set so that, when the destination of traffic is the server 150 that is large in RTT, the traffic destination is changed to a nearer server whose RTT is equal to or less than a threshold.

In this manner, when traveling of one terminal 170 causes switching of the access point 160 to which the terminal 170 is coupled, the communication apparatus 140 can autonomously change the destination of traffic of the terminal 170 to another server 150 that is associated with the same aggregation group and that is small in RTT, based on the settings set in the communication apparatus 140. The terminal 170 is thus freed from the need to change the traffic destination to the IP address of a small-RTT server when transmitting traffic, and can automatically couple to the server 150 that is small in RTT under control of the communication apparatus 140.

A fifth feature of this invention involves, in the second feature, associating an aggregation group with the IP addresses and port numbers of a plurality of servers that provide software resources. The IP addresses and port numbers of one server 150 and another server 150 that are associated with the same aggregation group are associated with each other, and, when a switch is made from one aggregation group to another as the aggregation group that is associated with a combination of a terminal and an application program, the network control server 100 issues to the relevant communication apparatus 140 an instruction in which the IP address and port number of the terminal are specified.

In this manner, when a switch is made from one aggregation group to another as the aggregation group that is associated with a combination of one terminal 170 and an application program as a result of the switching of the software resource providing server 150 that is associated with the combination of the terminal 170 and an application program, the communication apparatus 140 can transfer traffic of the combination of the terminal 170 and an application program that has switched aggregation groups to a destination different from the destination of another traffic flow of the previous aggregation group that has the same IP address and port number of the server 150, by following the instruction from the network control server 100.

A sixth feature of this invention involves, in the first feature, determining an aggregation group for a combination of one terminal 170 and an application program based on demanded communication characteristics, which are set for each combination of one terminal 170 and an application program, and on the location of the terminal 170 in the network 130. Demanded communication characteristics can thus be fulfilled for each combination of one terminal 170 and an application program.

The computers, processing units, and processing means described related to this invention may be, for a part or all of them, implemented by dedicated hardware.

The variety of software exemplified in the embodiments can be stored in various media (for example, non-transitory storage media), such as electro-magnetic media, electronic media, and optical media and can be downloaded to a computer through communication network such as the Internet.

This invention is not limited to the foregoing embodiments but includes various modifications. For example, the foregoing embodiments have been provided to explain this invention to be easily understood; they are not limited to the configurations including all the described elements.

<Supplement>

There is provided a computer system, including:

servers coupled to a plurality of communication apparatus to provide software;

terminals coupled to the plurality of communication apparatus to use the software;

a network for coupling the plurality of communication apparatus; and

a management computer, which is coupled to the network to manage the plurality of communication apparatus and the servers,

the management computer including:
an aggregation group management module configured to assign a combination of the terminals that share the same server as a server that provides the software to the terminals and software that is run by the terminals to a logical aggregation group; and
a path setting module configured to set communication paths of the plurality of communication apparatus, on an aggregation group-by-aggregation group basis.

Further, there is provided a management computer, which is coupled to a network to manage a plurality of communication apparatus and servers in a system,
the system including:
   servers coupled to a plurality of communication apparatus to provide software;
   terminals coupled to the plurality of communication apparatus to use the software; and
   a network for coupling the plurality of communication apparatus,

the management computer including:

an aggregation group management module configured to assign a combination of the terminals that share the same server as a server that provides the software to the terminals and software that is run by the terminals to a logical aggregation group; and

a path setting module configured to set communication paths of the plurality of communication apparatus, on an aggregation group-by-aggregation group basis.

Further, there is provided a non-transitory computer-readable storage medium having stored thereon a program for controlling a management computer including a processor and a memory, the program controlling the management computer to execute:

a first procedure of assigning a combination of terminals that share the same server as a server that provides software to the terminals and software that is run by the terminals to a logical aggregation group; and

a second procedure of setting communication paths of communication apparatus, on an aggregation group-by-aggregation group basis.

What is claimed is:

1. A communication path management method for setting a path through which a terminal accesses a server in a system,
the system comprising servers coupled to a plurality of communication apparatus to provide software, terminals coupled to the plurality of communication apparatus to use the software, and a network for coupling the plurality of communication apparatus,
the communication path management method comprising:
a first step of assigning, by a management computer, which is coupled to the network to manage the plurality of communication apparatus and the servers, a combination of the terminals that share the same server as a server that provides the software to the terminals and software that is run by the terminals to a logical aggregation group; and
a second step of setting, by the management computer, communication paths of the plurality of communication apparatus, on an aggregation group-by-aggregation group basis.

2. The communication path management method according to claim 1,
wherein the management computer comprises a name resolution module configured to receive a domain name and sending an address in response, and
wherein the first step comprises associating each aggregation group with addresses and port numbers of some of the servers.

3. The communication path management method according to claim 2,
wherein each of the plurality of communication apparatus is capable of changing at least one of a destination address of traffic or a transmission source address of the traffic, and
wherein the communication path management method further comprises a third step of interchanging, by the management computer, addresses and port numbers of one server and another server that are associated with the same aggregation group.

4. The communication path management method according to claim 3, wherein the management computer executes the third step when a given trigger event occurs.

5. The communication path management method according to claim 1, wherein the second step comprises setting, when a delay in communication between one of the terminals and one of the servers exceeds a given threshold, another server belonging to the same aggregation group that has the communication delay equal to or less than the given threshold for the one of the terminals.

6. The communication path management method according to claim 1, wherein the second step comprises notifying, by the management computer, when a combination of one terminal and software is switched from one aggregation group to be associated with another aggregation group, a relevant one of the plurality of communication apparatus by specifying an address and port number of the one terminal.

7. The communication path management method according to claim 1, wherein the first step comprises assigning the aggregation group based on demanded communication characteristics, which are set for each combination of one terminal and software, and on a location of the one terminal in the network.

8. The communication path management method according to claim 1, wherein the second step comprises:
calculating a cost of the servers and a cost of the network based on a combination of the terminals and software; and
setting, in the plurality of communication apparatus, communication paths in which a sum of the cost of the servers and the cost of the network fulfills a given condition.
